(19) United States
(12) Patent Application Publication
(10) Pub. No.: US 2018/0260521 A1
(43) Pub. Date: Sep. 13, 2018

(54) METHOD AND APPARATUS FOR MULTIPLE DOT PLOT ANALYSIS

(71) Applicant: SHINE Biopharma Inc., Seoul (KR)

(72) Inventor: Changhoon KIM, Seoul (KR)

(21) Appl. No.: 15/880,934

(22) Filed: Jan. 26, 2018

(30) Foreign Application Priority Data
Mar. 9, 2017 (KR) 10-2017-0030200
Oct. 1, 2017 (KR) 10-2017-0128472

(51) Int. Cl. G06F 19/22

(52) U.S. Cl. CPC G06F 19/22

(57) ABSTRACT

The present disclosure relates to a method for analyzing a genome sequence, and more particularly, to a genome analysis method for modifying an existing reference genome sequence information. More specifically, the present disclosure relates to a genome analysis method for modifying sequence information of an existing reference genome, in which the genome assembly of a test sequence using a de novo assembly is compared with an existing reference genome using a multiple dot plot analysis method to quickly and efficiently perform gap closing of an existing reference genome. The present disclosure also relates to a method for identifying gene variations on the genome sequence of a subject specimen by comparing a reference sequence modified by the genomic analysis method and a de novo assembled test sequence. In particular, it relates to a method for identifying haplotype-specific gene variations.

### CROSS-REFERENCE TO RELATED APPLICATIONS

This application is based on and claims priority to Korean Patent Application No. 10-2017-0128472, filed on Oct. 1, 2017 and 10-2017-0030200, filed on Mar. 9, 2017, with the Korean Intellectual Property Office, the disclosure of which is incorporated herein in its entirety by reference.

### FIELD

The present disclosure relates to a method for analyzing a genome sequence, and more particularly, to a genome analysis method for modifying an existing reference genome sequence information. More specifically, the present disclosure relates to a genome analysis method for modifying sequence information of an existing reference genome, in which the genome assembly of a test sequence using a de novo assembly is compared with an existing reference genome using a multiple dot plot analysis method to quickly and efficiently perform gap closing of an existing reference genome. The present disclosure also relates to a method for identifying gene variations on the genome sequence of a subject specimen by comparing a reference sequence modified by the genomic analysis method and a de novo assembled test sequence. In particular, it relates to a method for identifying haplotype-specific gene variations.

### BACKGROUND

Work on the completion of the genome sequence of an organism is an important task in the comparative analysis, function and structure studies of the genome. With the development of DNA sequencing analysis methods, the genome sequences of many species are now being revealed. Bioinformatics research using computational, mathematical, and statistical methods to obtain useful knowledge from large amounts of data obtained from organisms is becoming an essential tool for analyzing biological information.

Analysis of genome sequence information plays an important role in the field of precision medicine, which studies individual genomes and develops personalized medicines. Genomic sequences of target specimen individual were sequenced by a method for analyzing a precision medicine based on genome sequence information analysis, and a “reference genome” was compared as a control to find a structural variation. It is necessary to study the correlation between structural variation and disease or functional change. In order to perform efficient and meaningful structural variation searches, reference genome assemblies are needed that have a high completeness as a control, reflect the natural genome structure, and represent racial specificity. There have been various attempts to improve the completeness of the reference genome.

The term “reference genome” refers to sequence information representing a gene of a species. One of the biggest challenges in sequencing an organism's chromosomes is that its absolute size is so large that current technology does not allow reading from one end to the other end at a time. Thus, researchers extract genomic DNA from biological samples, make them into millions of small fragments, and then sequence each fragment. The consecutive sequence of these individual fragments is called “reads” and consists of 100 to 1000 nucleotide bases, depending on the technique used. Then, the sequence of each read is assembled, which is like a work of completing a big picture puzzle from small puzzle pieces. As technology advances, new sequence modification work and resulting modification information continue to occur, and in between each version the reference genome is continually updated with a modified version, referred to as “patches.” The Genome Reference Consortium (GRC) is in charge of a systematic update. For humans, the current reference genome is GRCh38. This version is the most recent version released in 2014, and previously. GRCh37 released in 2009 was used as a reference genome.

The Human Genome Project builds a BAC clone library from genomes obtained from a large number of donors and uses these libraries to complete genome sequencing using a clone-based assembly approach and a Sanger sequencing method. Among these, BAC clones derived from the RPCI-11 library composed of donors of African-European origin provide a large portion of the standard reference sequence (about 70%), and sequences derived from BAC clones derived from other libraries contributed in constituting reference sequences. The draft sequence of the human genome published in 2001 in the Human Genome Project covers about 87% of the genome and covers about 90% of euchromatic DNA, the region where gene expression is activated. There were about 145,000 gaps in the genome assembly. It took additional time and money to sequence the remaining 10% euchromatic DNA, and in 2004 a “finished” genome sequence was published. In the finished version, 99% euchromatic DNA and 93% of total DNA (heterochromatic region with gene expression inactivated with euchromatic region) sequences were sequenced. The completed sequence had 341 gaps (International Human Genome Sequencing Consortium, Nature, 2004).

With the development of sequencing technology, genome sequencing has become very common, but genome assembly remains a challenge. To accurately understand the genetic variation of the genome, a high-accuracy genome assembly should be used as a comparative reference. The more accurate the reference genome, the more accurate the search for genetic variation and the structural significance analysis. When data cannot be obtained with complex genomic structures or sequencing gaps, it is impossible to detect genetic variations that cause disease.

The genome “assembly” process is broadly divided into two steps: aligning and overlapping a large number of reads that are sequence fragments to create a “contig” with no gap in the form of an adjacent sequence; ordering one or more contigs, establishing directionality and connecting them to form a “scaffold.”

Since there is a gap in the genome assembly that completes the entire consecutive sequence based on the fragment sequence read information, there is a limit to construct an assembly of one perfect continuous sequence. The reason for this is that firstly, lack of sequencing amount causes uncovered region unless DNA sequencing is done much more than whole genome. This problem can be solved with more sequencing. The second reason is that the genome of the organism, especially the higher organisms, there exist a lot more of repeated DNAs. Another reason is that sequencing itself is difficult in regions where G/C is large, or secondary structures and hairpin structures are formed. In such a case, it is not solved by a lot of sequencing, but a new approach is needed.

Gaps that can exist in genome assemblies are divided into two types. The first type of gap is a sequencing gap, which occurs when the position and orientation of the contig are known but there is no sequence information in between. Scaffold can be created by connecting adjacent contigs away from the sequencing gap. The second type of gap is a physical gap in which information about an adjacent contig is not known. For example, if there is no information linking one contig to another contig, then it will not be possible to know where it will be on the genome. In order to fill the physical gap, it is necessary to acquire information linking the contigs through screening of appropriate clones using a conventional library screening method such as hybridization or sequencing using a long insertion clone.

Current GRCh38, the most complete version of the reference genome, has undergone considerable upgrades compared to the original version, and by virtue of its accuracy and completeness, it is used as the standard sequence for comparison in multiple genome sequencing projects, but there are still limitations.

The first problem lies in that there is a limitation that the reference genome does not reflect racial diversity. The Human Genome Project is a genome sequencing project conducted in the western region, using samples donated from participants in smaller countries, with nearly 70% of sequence information coming from a donor genome that is presumed to be of African-European race. Therefore, there is a limitation that it does not faithfully reflect the diversity of the whole race.

The second problem lies in that there are still a large number of gaps in the latest version of GRCh38. In the “finished” reference genome released by the Human Genome Project in 2004, there were about 340 gaps. After that, attempts were made to close the gaps to check the previously unknown sequences to fill the gaps. However, new gaps were extended. For example, Bovee, et al. (2007) constructed a variety of genomic fosmid libraries as new DNA sources, mapping clones that previously remained as gaps, and closed 26 gaps corresponding to 10% of the 250 euchromatic gaps known at the time, and simultaneously adding 67 euchromatic gaps existing in the other regions.

A further problem lies in that the reference genome is a patchwork from a large number of donors and is an artificial form that does not exist in the natural world. The reference genome source is a diploid, with two different copies on each chromosome, in particular, a structural variation is a different type, whereas the reference genome is a patchwork derived from multiple clone sources and is presented in one mixed form of haploid. As a result, two versions of a structural variant are combined to represent a new genotype that does not exist in the natural world, or the sequence information cannot be consecutively linked, thereby producing a gap.

The Sanger method, which was initially used as a method to perform short fragment sequence sequencing, is inconvenient and time-consuming operation because DNA fragments were separately separated and read out by radioactivity, so that a technique for automating the Sanger method has developed. Next-Generation Sequencing (NGS) technology is a method to break down a single genome into numerous pieces to generate large quantities of short-length (100 to 200 nucleotides) reads, read each read simultaneously, use computational techniques, and assemble and decode the genomic information, thereby enabling to perform low-cost, high-efficiency genome sequencing. The advancement of NGS technology has led to the rapid development of DNA genome sequencing. The Sanger method requires about 500 bp of template DNA for sequencing, which requires library construction and cloning procedures, which is time consuming and costly. In NGS technology, the process of obtaining clones was simplified, and clonal amplification was performed by directly cutting the DNA into appropriate short fragments and directly amplifying them by PCR using primers. Next NGS (Next NGS) technology further improves the accuracy and sequencing speed by reducing the error in the clone amplification process by PCR by sequencing in real time directly from single DNA molecule without clone amplification (Kwon, Sun-II, 2012). Single-molecule, real-time (SMRT), a single-molecule sequencing technology developed by Pacific Biosciences, has increased the read length to over 10 kb on average.

The assembly type that constitutes the entire base sequence based on the base sequence information of the read piece includes a “reference assembly” which utilizes prior knowledge of the reference for sorting the base sequence information and a “de novo assembly” which does not depend on the reference information and reconstructs the base sequence information into the original entire sequence by sorting and recombination. Despite the advantages of NGS technology, which has significantly reduced time and cost compared to traditional Sanger sequencing-based analysis methods, it is still difficult to complete the entire sequencing with de novo assembly using NGS technology until now. The reason for this is that the assembly process is easier as the length of reads are longer and the overlap region is larger, but the NGS technology has a much shorter read length than the Sanger sequencing-based analysis method, has a higher total number of reads to be assembled. This is because there are many repetitive intervals where a high frequency occurs in the genome, and there is a high possibility that a false-positive overlap occurs (Information Science Society, 2013). Prior to the present disclosure, a method for performing genome sequence assembly by selecting optimal assemblies using algorithms of open-source software by a method of de novo assembly for a fungus genome has been described (Korean Patent Laid-Open Publication No. 10-2017-0053147). However, fungi have an average size of about 35 Mb and do not have the size and complexity of large genomes such as the human genome size 3 Gb.

In an attempt to close the gap, a method in which a genome library was constructed from a separate DNA source and a gap-spanning clone mapped near the gap region was obtained and sequenced was used (Bovee 2007). Attempts have been made to reveal structural variations by performing gap closure through full-field genomic sequencing with an attempt to close the gap using the NGS technology. In one such study result (Chaisson 2015), 50 clones were cloned in 164 known interstitial euchromatic gaps of GRCh37, and an additional 40 were extended, resulting that a new sequence of 398 kb and 721 kb, respectively, has been added to the genome. However, the limitation of the gap closing method using only the NGS technology based sequencing is that with a local assembly alone depending on the reference genomic information, it is difficult to map to a reference in a wide range exceeding the read length or complex areas where a very similar repeating sequence appears and dislocation appears. Therefore, in the above study, a clone-based hierarchical approach was used separately to solve regions where could not be solved or extended with the SMRT WGS read alone.

A “dot matrix” analysis method or a dot plot analysis method is a method mainly used by biologists to compare two or more proteins or nucleic acid sequences. “Dot plots” can be used to interpret and analyze evolutionary relationships between sequences by studying conserved domains, reverse matches, and repeats as visual results of a dot matrix analysis. The dot plot is a table visually showing whether there is a common or different feature between the information arranged in the coordinates by arranging the coordinate information on each axis of the orthogonal coordinates system. If the information arranged on the axis is the sequence of genes, this visualizes the difference between two gene sequence information and the location information where the difference occurs. The basic principle of the dot plot is that one sequence is arranged along the x-axis and the other sequence is arranged along the y-axis, and if a base corresponding to position j of the sequence of the y-axis corresponding to position i in the sequence of the x-axis is the same, it will draw “dot”. There is an advantage that if the gene sequence is inaccurate or empty, that is, the location of the error can be seen at a glance. In addition, if one of the two genes is a reference gene and the other is a comparative gene, the difference in the sequence indicates the variation information of the gene sequence, so the position of the sequence variation can be known through the comparison information of a dot plot arrangement. The principle of a dot plot has been introduced in the 1970s, and the ‘Dotter’ program is the first interactive dot plot analysis method with a graphical user interface (Krumsiek 2007).

According to Gonzalez, et al. (2008), it has been disclosed that two sequences are compared by placing different sequences on an orthogonal dot plot. In this case, the different positions between the two sequences in the dot plot, that is, the region where the originally known sequence and the target sequence for comparison do not coincide with each other can be recognized as a gap of the target sequence for comparison or a region where a structural variation occurs. Therefrom, it is possible to modify or add information about the gap of the sequence and the variation of the sequence of what is desired to be known. As such, it is known that the dot plot is used for comparing sequence information. However, when the sequence of the reference genome (already known genome sequence) is placed on one axis and the sequence to be compared is placed on another axis, it can be understood that it is used only in a limited manner if information on differences in the different sequence dot plot is found. It was not efficient to simply place the reference genome sequence and the newly assembled sequence on the x and y axes, respectively, and simply compare the arrangement. Moreover, as described in the above study, prior to the present disclosure, a dot plot analysis method is used to locate a sequence to be newly assembled depending on information of a known reference genome. In order to close or extend a gap existing in a reference genome, there was no case used to modify the information about the assembled genome itself. Further, no attempt has been made to solve the gap using a multiple dot plot that compares the self-dot plot of the reference genome assembly with the self-dot plot of the test sequence assembly.

Genomic sequencing and bioinformatics analysis have sought to find functionally important genetic variations. Human genome variations include single nucleotide polymorphism SNPs and structural variants (SV), and recent study results have shown that these genetic variations are involved in phenotype changes, susceptibility to disease, and differences in response to drugs. Much research has been done on patterns of single-nucleotide polymorphism (SNP) among human genome variations and genotyping analysis has been done in population samples. On the other hand, research has begun to increase in recent years as the effect of SV, which is structural variation in the human genome, on the phenotypic difference and tendency to susceptibility to disease has been known only recently. While single nucleotide polymorphism SNP accounts for 0.1% of the human genome variation, structural variation SV accounts for 1.2% (Tattini et al. 2015). SV is one of the genomic variations that refer to segmental duplication, copy number variation, translocation, inversion, insertion, and deletion. In the past, sequence variations of 1 kb or more were the criteria of SV judgment. However, recently, it has been revealed that the development of various sequence analysis methods enables analysis of various SVs and that SVs occurring in small regions also affect protein deformation and diseases. Accordingly, criteria were changed to include 50 bp or more of gene rearrangements (Eichler et al., 2011).

SV is known to play a role in phenotypic diversity when present in healthy individuals and it is known that genetic diseases, diseases of the nervous system, and cancers affect the disease emergence and mechanism of action of drugs. Therefore, a complete analysis work of the SV region is expected to help identify the causative genes of the disease and develop treatment methods. It is known that many SVs exist in the genome gap region. Structurally polymorphic regions, particularly overlapping regions, can contribute to the formation of gaps in the genome assembly, particularly when adjacent clones in the gap region are derived from two structurally mutated haplotypes, gaps may be generated (Bovee 2007).

It has been known that genetic traits such as color blindness, Rh blood group sensitivity, hemophilia and beta- and alpha-thalassemia are due to the complex structural transformation of genes. In addition, Prader-Willi syndrome and velocardiofacial syndrome are known to be genetic diseases with changes of millions of base pair sequences (Eichler et al. 2007). In addition to the role of SV in these rare genetic diseases and genomic diseases, it is known that many common structural variations play an important role in normal phenotypic diversity and susceptibility to disease. For example, deletion of the UGT2B17 gene is known to contribute to racial individual differences in terms of testosterone metabolism differences and risk of prostate cancer. Increasing the copy number of the CC31 gene is known to lower the probability of getting HIV infection and lower the probability of progressing to ADIS. It is also known that a decrease in the DEFB4 gene copy number increases the probability of suffering from colonic Crohn's disease and a decrease in FCGR3 copy number increases the probability of suffering from glomerulonephritis (Eichler et al. 2007).

When the reads generated for the sequence analysis are mapped to the reference genome, signals of various patterns that do not exactly match the reference genome are actually detected. The position where these signals occur is the SV position. This signal can also indicate where the gap is highly likely to occur, or where the gap is located. Therefore, filling the gap of the reference genome also provides more reliable information when comparing the genome of the target (patient, etc.) and the reference genome to those who want to detect SV at the same time. In other words, the analysis of the SV and the work of filling of the gap correspond to a method of modifying the mutual information errors at the same time.

Conventionally, array-based methods and PCR-based analysis methods have been used many times as a method to detect SVs of the genome. Array-based comparative genome hybridization (array-CGH) is used to compare the fluorescence intensity patterns between the reference genome and the subject genome for comparison and is effectively used to scan the entire genome to find a new copy number variation (CNV) (Feuk et al., 2006). PCR-based methods are used to target and analyze specific regions by screening SVs. The most well-established method is real-time quantitative PCR (qPCR), which well finds individual deletions and duplications, but there is a disadvantage in that it is weak in detecting multiplexing. The array-based CGH has been used to concentrate on the findings of copy number variation, and there is a disadvantage in that resolution and analysis performance depend on the DNA probe, and disadvantage that translocation or inversion cannot be found.

As an additional way of detecting SV, DNA sequences from different sources can be compared to each other on a computer for identification in silico. In this method, two assemblies, each derived from a unique human DNA source, are arranged to detect the difference. The advantage of this method is that it can detect all kinds of variants. Another advantage is that the resolution is unlimited and variants can be identified at the nucleotide level (Feuk et al. 2006). Another type of in silico method is the paired-end sequence method. The method is to arrange the anchor points derived from the genomic library of the selected genome from the sequences corresponding to both ends of the clones into the reference assembly and compare the distance between them with the expected size in the clone. The presence of a difference suggests the possibility for potential insertion or deletion variants. This method is also suitable for detection of some inversion. In addition. SV can be verified by analyzing how many sequences are sequenced from shotgun sequencing data (sequence read-depths) (Feuk 2006).

A single strand gap nicked in DNA was created by unusual patterns of sequence structural variations and other functional molecular information. DNA was then labeled to form a specific sequence motif, mapping the physical distribution and frequency of sequence motifs and disclosing use for genome mapping or identification of a pathogen genome (Korean Patent Laid-Open Publication No. 10-2012-0084313). For example, it is known that the BCR gene and the ABL1 gene inversion form the Philadelphia chromosome and are a major cause of leukemia. BCR and ABL1 gene inversions are labeled with probes and clinical diagnosis is made from a specific bar coding pattern.

Most multicellular organisms have diploid chromosomes, and have various forms of alleles that determine one genetic trait. Two alleles exist in the same region corresponding to the homologous chromosome, forming two same forms as one set, one is derived from a paternal line and one derived from a maternal line. When the genetic information is transferred to the next generation, the transfer of the DNA sequence occurs on a block-by-block basis. The DNA sequence of this block is a haplotype. In other words, the set of adjacent SNPs that are statistically associated on one chromosome and tend to be inherited together is called a haplotype. In addition to the group of alleles on the haploid representing only one of the chromosome pairs, the pattern in which the variation of the gene occurs is inherited as one set, which is called a haplotype. In the conventional genome sequence analysis, such as reference genome assemblies, haplotype information is limited because the genomic sample is based on samples derived from diploids, which were randomly cut into small pieces and then assembled from the read information. This is because the artificial patchwork is created, not the structure of the natural diploid genome. In addition, in the case of the reference genome, the libraries used for sequencing are derived from a large number of donors, mixed with multiple genomic sources, resulting in mixed haplotypes and artificial haplotypes that do not exist in nature. The recently developed second generation NGS analysis method creates a shorter sequence fragment and thus presents a limitation in expressing the complex structure of the genome in assembly. Haploid phasing refers to the analysis of statistically-related SNP aggregates on chromosomes to distinguish between the haploid derived from the paternal line and the haploid derived from the maternal line. If the NGS read length is short, it is not possible to classify haploid because a plurality of SNPs is not included in one read. In the long read data, it is possible to analyze the related genetic variation pattern for phasing. Contigs that assemble the reads of haploid are referred to as haplotig.

Genetic variations in the genome, particularly structural variants, need to be further improved in the “completeness” of the reference genome in order to increase efficiency and accuracy in SV searches. Closure or extension of the regions that still remain in the gap is necessary to enhance the completeness of the reference genome assembly. In order to be able to detect sequence information or structural variation that does not exist in the reference genome, the reconstituted sequence information is needed as a de novo assembly that does not depend on the reference genome. In order to overcome the problems caused by the dependence of the short read sequence information of the NGS analysis method and the limitations in reflecting the haploid information in constructing a de novo assembly, it is necessary to use the latest NGS method and read the sequence as long as possible as a long read sequence, and reflect the haploid information.

### Patent Documents

(Patent document 0001) BIONANO GENOMICS, Korean Patent Laid-Open Publication No. 10-2012-0084313 (laid-open date: Jul. 27, 2012)
(Patent document 0002) RHEE SANG YOUL, Korean Patent Registration No. 10-1533395 (publication date: Jul. 8, 2015)
(Patent document 0003) GNC BIO, Korean Patent Registration No. 10-1632881 (publication date: Jun. 23, 2016)
(Patent document 0004) KOREA UNIVERSITY RESEARCH AND BUSINESS FOUNDATION, Korean Patent Registration No. 10-2017-0053147 (publication date: May 15, 2017)

### Non-Patent Documents

(Non-patent document 0001) International Human Genome Sequencing Consortium, “Finishing the euchromatic sequence of the human genome,” Nature, 2004, 431: 931-945.
(Non-patent document 0002) Feuk, L., “Structural variation in the human genome,” Nature reviews. Genetics, 2006, 7(2): 85.
(Non-patent document 0003) Eichler, E. et al., “Completing the map of human genetic variation,” Nature, 2007, 447(7141): 161-165.
(Non-patent document 0004) Bovee, D. et al., “Closing gaps in the human genome with fosmid resources generated from multiple individuals,” Nature Genetics, 2007, 40(1): 96-101.
(Non-patent document 0005) Gonzalez, J. et al., “Clustering exact matches of pairwise sequence alignments by weighted linear regression,” BMC bioinformatics, 2008, 9(1): 102.
(Non-patent document 0006) Kim, C. “Birth of an ‘Asian cool’ reference genome: AK1.” BMB reports, 2016, 49(12): 653.
(Non-patent document 0007) Tattini, L. et al., “Detection of genomic structural variants from next-generation sequencing data,” Frontiers in Bioengineering and Biotechnology, 2015, 92(3): 1-8.
(Non-patent document 0008) Chaisson, J P. et al., “Resolving the complexity of the human genome using single-molecule sequencing,” Nature, 2015, 517(7536): 608-611.
(Non-patent document 0009) Seo, J. et al., “De novo assembly and phasing of a Korean human genome,” Nature, 2016, doi:10.1038/nature20098.
(Non-patent document 0010) Jung Kwang Soo, Korea Centers for Disease Control and Prevention, Weekly Health and Disease, “Structural variation detection based on next generation sequencing technology.” 2011
(Non-patent document 0011) Kim Jung Min, Korea Centers for Disease Control and Prevention, Weekly Health and Disease, “Research trends on disease-associated genetic variation function.” 2013, 6(10)

### SUMMARY

The reference genome for analysis of the existing human genome structures is being used as a reference with a base sequence gap due to the limitations of sequencing and assembly. In addition, this human reference genome is composed mainly of western genomes (African-European genomes). In fact, under the background that the complexity and diversity of the genome are revealed more, there is a growing need to create a human reference genome that can be more accurate standard to search for the race specific structure variation through the analysis of Asian unique reference genome.

In order to clarify the cause of human diseases through analysis of biological genetic information, the reference genome information must be accurate to increase accuracy even when analyzing the structural variation SV. Therefore, it is required to improve accuracy of the reference genome in terms of precision medicine development.

The present disclosure provides a method for modifying reference sequence information in which sequence information of an entire sequence is reported, in which the method includes the following steps:

Reconstructing the entire sequence by assembling a genome for a test sequence with a de novo genome assembly;

comparing the reference sequences to each other to generate a self-similarity dot-plot;

identifying a sequence gap on a self-similarity dot plot matrix of a reference sequence;

selecting a sequence at a corresponding position in the sequence mapped to the reference sequence region, and comparing the test sequences assembled with the de novo genome to each other to generate a self-similarity dot plot;

identifying a sequence gap shown in the reference sequence by aligning the self-similarity dot plot of the de novo genome assembled test sequence and the self-similarity dot plot of the reference sequence on a screen in accordance with the size ratios; and

closing or extending the sequence gap shown in the reference sequence with the de novo genome assembled test sequence.

The method of modifying the reference sequence information of the present disclosure may additionally include the step of using local realignment or reassembly, or spanning reads.

More specifically, the reference genome in which the sequence modification method of the present disclosure can be used is a prokaryote, eukaryote or viral genome sequence or a part thereof, preferably a human genome sequence, an animal genome sequence, a plant genome sequence, a bacterial genome sequence or a part thereof.

In addition, in the sequence modification method of the present disclosure, the de novo assembly of the test sequence may be a combination of one or more of the methods selected from PacBio SMRT long read, BioNano Genomics next-generation maps, Illumina HiSeq short read, 10× Genomics GemCode linked read and BAC clone sequencing methods.

In addition, the present disclosure provides a method of identifying a gene variation in which the method includes a single nucleotide polymorphism (SNP), insertion deletion (indel) or structural variant (SV) on the genomic sequence of the subject specimen, as compared to the modified reference sequences and/or de novo assembled test sequences according to the method of the present disclosure.

In addition, the de novo assembled test sequence additionally constitutes the de novo assembly of haplotig to represent the haplotype on the chromosome. The present disclosure provides a method for identifying a gene variation in which the method includes a haplotype-specific single nucleotide polymorphism, insertion deletion, or structural variants as compared to the genome sequence information of the subject specimen.

Also, provided is a method for predicting disease diagnosis and phenotypic diversity by searching a structural variant on a test sequence and a reference sequence using reference sequence information modified by the sequence modification method of the present disclosure.

In addition, the present disclosure provides a system for modifying a reference assembly, including the following components, with a de novo assembly.

The system includes: a genome assembly for reconstructing the entire sequence by assembling a genome with a test sequence into a de novo genome assembly;

a dot plot generating unit for comparing the reference sequences with each other to generate a self-similarity dot plot;

a dot plot analyzing unit for identifying the sequence gap on the self-similarity dot plot matrix of the reference sequence:

a dot plot generating unit for selecting a sequence of a position corresponding to a sequence mapped to the reference sequence region and comparing the de novo genome assembled test sequences to each other to generate a self-similarity dot plot;

a multiple dot plot analyzing unit for aligning the self-similarity dot plot of the de novo assembled test sequence and the self-similarity dot plot of the reference sequence on a screen in accordance with the size ratios to identify the sequence gap appearing in the reference sequence; and

a sequence information correction unit for closing the sequence gap shown in the reference sequence or extending the gap with the de novo assembled test sequence.

The modification of the reference sequence information of the method according to the present disclosure can be useful for searching a structural variant by increasing the completeness of the reference genome by gap closing.

According to the present disclosure, a self-dot plot, which is a genome sequence created by analyzing the sequence of a human chromosome genome structure called AK1, which is Asian specific, to fill a vacant sequence of a reference genome for analyzing a conventional human chromosome genome structure, and a self-dot plot of a conventional reference genome sequence are prepared to compare two self-dot plots and to find the vacant position of each sequence. Then, by providing a method of filling the other party's sequence corresponding to the position in one's vacancy, it can improve the accuracy of the existing reference genome structure analysis. In addition, it is possible to analyze a novel chromosomal structural variation (SV) region through a direct sequence comparison between the modified conventional reference genome sequence and AK1 assembly sequence, and thus it can be used for detailed disease information prediction and diagnosis using chromosomal SV information.

The present disclosure relates to a method for modifying a reference genome sequence to create a reference genome with improved accuracy by closing gaps present in a reference genome assembled by a conventional method for the organism genome of an analysis target. In one embodiment, the present disclosure reconstructs a target organism-derived test sequence with a de novo assembly to close the gap in the reference genome sequence of the target organism.

In another embodiment of the present disclosure, the target organism is human, and provides a method of genome analysis that fills the gaps in the human reference genome sequence. In one embodiment of the present disclosure, the test sequence to be de novo assembled is the AK1 derived sequence which is an Asian genome. The human reference genome (GRCh38) currently used is mainly derived from white and black, and is used as a universal reference for general research and medical applications. However, race-specific variants, such as Asian-specific variants, are not represented in these universal references (Kim 2016). Thus, research efforts to map diversity, including gene frequency and structural variation, can benefit from new references that can reflect racial specificity.

### BRIEF DESCRIPTION OF THE DRAWINGS

FIG. 1 is a flowchart illustrating the processes of assembling the Asian genomic AK1 genome with a de novo assembly using a sequencing technique such as a long read sequencing platform, a short read sequencing platform, a genomic mapping platform, etc., and closing the gap existing in the reference genome based on the de novo assembled AK1 sequence information and analyzing genome specific variants.

FIG. 2 illustrates an example of closing the gaps present in the reference genome (gap_367) and an extended gap (gap_368) using the de novo assembled Asian genome AK1 assembly and BAC.

FIG. 3 illustrates an example of closing the gap of the reference genome (gap_367) and an extended gap (gap_368) by preparing a multiple dot plot using the de novo assembled Asian genome AK1 assembly.

FIG. 4 illustrates the number of euchromatic gaps (red) compared to the number of gaps (gray) present on each chromosome using the de novo assembled Asian genome AK1 assembly.

FIG. 5 is a graph illustrating the number of gaps closed only by the AK1 assembly, the number of gaps closed by the local assembly, and the number of gaps closed only by the long read. It also illustrates the number of gaps extending only to the AK assembly, the number of gaps extending to the long read, and the number of open gaps.

FIG. 6 illustrates the overall distribution of deletions, insertions, translocations, and complex variants by directly comparing the existing reference genome. GRCh37, with the AK1 assembly at base-level resolution. The outer pie graph represents the new type of each SV type. Of the total 18,210 SVs identified, a total of 65% (11,927) SVs are new SVs that have never been reported.

FIG. 7 illustrates the distribution of insertions and deletion variants when comparing AK1 and GRCh37 compared to previously reported SVs.

FIG. 8 illustrates allele frequencies in 45 species of Asian specific insertion variants.

FIG. 9 illustrates that an Asian specific insert in ANO2 occurs in an East Asian (EAS) linkage disequilibrium (LD) block.

FIG. 10 illustrates the genome-wide map of the heterozygous region and the expression of haplotype A and haplotype B on a log scale.

FIG. 11 illustrates the HLA gene in the haplotype-phased MHC class II region.

FIG. 12 illustrates the haplotype of CYP2D6 and CYP2D7 identified by de novo assembly-based phasing.

FIGS. 13, 14, 15, and 16 illustrate examples of gaps closed in the reference sequence by a multiple dot plot analysis of the AK1 assembly and the reference genome GRCh38, which are de novo assembled test sequences.

### DETAILED DESCRIPTION

The present disclosure may be more readily understood by reference to the following detailed description taken in conjunction with the accompanying drawings and embodiments which form a part of this disclosure. It is not intended that the invention is limited to the specific devices, methods, applications, conditions or parameters set forth and/or presented herein, and the terminology used herein is for the purpose of describing particular embodiments only as examples, but is not intended to be limiting.

It is to be understood that the specific features of the invention described herein may be presented as an individual embodiment or a combination thereof.

The genome of the target organism to which the reference genome sequence is modified in the present disclosure may be a prokaryotic, eukaryotic, bacterial, viral, animal, plant, or human genomic sequence or part thereof. In an embodiment of the present disclosure, the target organism genome in which the reference genome information is modified may be a human genome. The reference genomic sequence may use GRCh37 or GRCh38. As a test sequence for de novo assembly. AK1, an Asian genomic sequence, may be used. The Korean individual AK1 genome shows remarkable structural differences when compared to the reference genome, and is a genome that can reflect the racial specificity which cannot be performed one by the reference genome analysis alone.

The genome used as a test sequence for de novo assembly may be assembled in a combination of one or more of PacBio SMRT long read, BioNano Genomics next-generation maps, Illumina HiSeq short read, 10× Genomics GemCode linked read and BAC Clone Sequencing methods.

The NGS sequencing method can be distinguished by a method using a short read or a method using a long read depending on the length of the read. The short read NGS sequencing method is largely divided into two categories: a method using ligation and a method using synthesis. The former one is characterized in that a probe sequence and a fluorescent material are attached and imaged. The latter one is characterized in that a fluorescent material is attached through a polymerase and imaged. There are SOLiD and Complete Genomics methods using ligation. There are CRT (cyclic reversible termination) method such as Illumina and Qiagen and SNA (single-nucleotide addition) method such as 454 GS and Ion Torrent platform using synthesis.

The sequencing method using long read is divided into two categories: SMRT method and synthetic based method using short read as virtual long read structure. The SMRT method includes PacBio sequencing. ONT (Oxford Nanopore Technologies), HeliScope (Helicos), and Starlight (Life Technologies). The method for making a virtual long read includes Illumina Synthetic long read, 10× Genomics (emulsion-based) platforms (Goodwin et al., 2016).

There are three technologies as a technology using NGS devices: clone amplification technology, massively parallel method, and sequencing by synthesis through cyclic sequencing. Roche's GS FLX, Life Technology's SoLid5500 series, and Illumina's Genome Analyzer HiSeq provide a sequencing method using the representative NGS technology (Kwon, Sun-II, 2012).

The next-generation NGS technology, a long read sequencing method, includes real-time long read sequencing platform technology and synthetic long read sequencing platform technology. The real-time long read sequencing platform is available from Pacific Biosciences (PacBio) SMRT technology, Oxford Nanopore Technologies (ONT). As synthetic long read sequencing platform technology, Illumina's synthetic long read technology for HiSeq2500 and 10× Genomics' emulsion-based sequencing Technology can be used.

Illumina's sequencing method produces 100 bp unit of short reads to read the entire nucleotide sequence. It takes a long time but has a short read length and low error rate. PacBio's sequencing method uses long read of 10 kbp unit on average. Many analyzes are possible for a short period of time, but the error rate is high. BioNano Genomics' method allows a very large range of analysis over an average of 100 kbp, but fragile sites occur and complete labeling is difficult.

For Illumina's Genome Analyzer, a primer complementary to the adapter was fixed and placed on the substrate. A single DNA fragment is ligated with the adapter and hybridized to the primer at sufficient spacing on the substrate. In this state, bridge amplification occurs, and then cycling sequencing is performed on that spot in the next step. Genome Analyzer HiSeq is used to read the sequence, which uses fluorescent tag DNA synthesis. In four different dNTPs (A, T, G, C), each different fluorescence is tagged and newly synthesized nucleotides are distinguished by color to read base sequence information.

Pacific Biosciences has developed a single DNA molecule sequencing called SMRT (single molecule, real-time) technology. A single molecule of DNA polymerase binds to the bottom of the sequencing chip, where it undergoes sequencing reactions with template DNA fragments, detects the reaction in real time, and reads the base sequence. When fluorescence is attached to the end of the phosphate group of the nucleotide and the base-binding reaction occurs, the fluorescence molecule is dropped and the fluorescence pulse is stopped. This signal change is detected and the CCD camera is used like the second-generation sequencer.

BioNano Genomics extracts DNA molecules from cells with the IrysPrep kit, labels IrysPrep-labeled DNA on specific sequence motifs, including nick sites, and then IrysChip linearizes the DNA in the NanoChannel array, and Irys devices automatically process monomolecular imaging using a NanoChannel array. When molecules and labels are created as images from the device's software, they are then mapped optically with the IrysView software.

An “assembly” that reassembles genome sequence information is classified into a “reference assembly” in which the sequences are already recombined long by aligning the reads to a known reference sequence, and a new “de novo assembly” which is newly reassembled without any reference. A “de novo assembly” refers to a method of reconstructing reads with sequences that are estimated to be the original entire sequence, using the nucleotide sequence information of the reads, without relying on the reference genome. As the algorithm for the de novo assembly method. Greedy graph method, OLC (Overlap-Layout-Consensus) method, De Brujin graph method and the like can be used.

When a de novo assembly is performed using NGS read data without evaluation information on the reference sequence, the longer the length of the read, the longer the contig will be formed, and the repeat section will be reduced to improve the accuracy of the assembly.

The modification of the reference genome assembly information in the present disclosure may preferably be to identify gap closing or structural variant. Gaps are present in many parts of the sequence where it is difficult to read or where the sequence repeats. The gap can be largely divided into a “spanned gap” and an “unspanned gap.” The spanned gap is that the end portions of two adjacent contigs are connected to the end sequenced plasmid. Most of these gaps can be sequenced and closed with a primer, and the sequence of contigs can be continuously extended to close the gap. The non-spanned gap is that the end of one contig is not connected to the end of another contig. They need to estimate adjacencies and extend sequences in other ways. One technique that can be used is to perform PCR on other contigs, analyze various forms of BAC subclones, or perform primer work directly on BAC (Nature 2004).

In the present disclosure, the terms “closing of gaps.” “closed” or “filling of gaps” and “filling” means that the gap is almost completely eliminated by revealing the sequence of the gap. The terms “extending” and “extended” of the gap means that the sequence of a part of both ends of the gap is newly filled.

There is provided a method of using a multiple dot plot analysis method using a de novo assembled genome sequence as a test sequence for modifying reference genome sequence information according to the present disclosure. Specifically, in the present disclosure, it was possible to close the remaining gaps in the human reference genome GRCh37 or GRCh38 using the AK1 genome assembly that was de novo assembled to the test sequence.

The method of modifying the reference sequence information of the present disclosure may further include the step of using local realignment or reassembly, or spanning reads. Local realignment or reassembly means a process of aligning reads on a reference and realigning or reassembling those mapped around. A spanning read means a read which can completely cover one gap. These methods may employ conventional methods known to those skilled in the art.

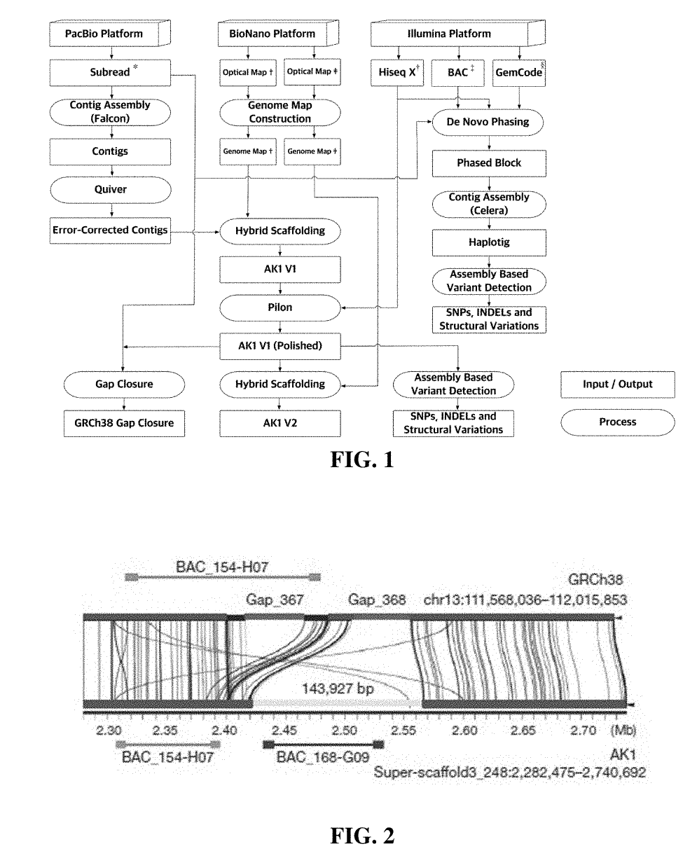

In one embodiment, the genome of the test sequence is sequenced using the PacBio platform, Illumina platform, GemCode platform, as illustrated in FIG. 1, and the entire sequence is recombined by the de novo genome assembly. SMRT sequencing was performed using PacBio platform, and reads were assembled and error-corrected with FALCON and Quiver to generate 3,128 contigs with a contig N50 length of 17.9 Mb. The contig thus obtained is used to assemble the scaffold. Physical mapping is performed using the BioNano Genomics Irys system. The Irys system is a program that maps contigs obtained from a next-generation mapping (NGM) to a larger scaffold, and uses unique sequence motifs to generate physical maps to obtain information about the large-scale structure of the genome. Mapping information is provided for creating a scaffold by providing information that visualizes the structure of the sequence over a longer range than the long reads made from the sequencing information obtained by using SMRT technology. Hybrid scaffolding is produced by integrating contigs and genomic maps. Polishing is done using Illumina reads to create the final assembly. Illumina's Hiseq X is a system in which the short reads are made into a library in paired-end form, then sequenced and assembled in a de novo manner, and can provide a lot of processable and accurate information at low cost. It provides information to the Pilon, which polishes the informational errors obtained from the long reads of the PacBio system. Using these three platforms, the information of the AK1 assembly modified and obtained is aligned and compared with the reference genome to fill the gap.

The present disclosure provides a genome analysis method for quickly modifying sequence information of a reference genome through a multiple dot plot analysis method using an assembly of de novo assembled test sequences. Preferably, as an assembly of the de novo assembled test sequence of the present disclosure, an Asian race specific AK1 assembly may be used.

The multiple dot plot analysis method reconstructs the de novo assembly of the test sequence independently of the reference genome assembly, generates each of the self-dot plot of the previously reported reference genome assembly and the de novo assembled test sequence, and resolves the gaps present in the reference genome by aligning the self-dot plot at a position corresponding to one screen.

“Self-similarity dot-plot” or “self-dot plot” refers to comparing the selected sequences on the x- and y-axes, respectively. The self-dot plot for each of the de novo assembled test sequence and reference sequence is prepared. In the self-dot plot, information of the same sequence is arranged on the horizontal axis of x-axis and the vertical axis of y-axis to confirm whether the gap exists and the size of the gap. The self-dot plot of the test sequence and the self-dot plot of the reference sequence are arranged on a screen in accordance with the size ratio. The chromosomal location information (coordinate) is compared with each other to adjust the chromosomal location information to correspond to the desired position. A multiple dot plot may be prepared by comparing two arbitrary sequences, but it is preferable to compare two sequences having a certain level of similarity in order to obtain a significant multiple dot plot. In order to select the corresponding de novo assembled test sequence region near the reference sequence region containing the gap to prepare a multiple dot plot, a conventional program (e.g., LASTZ) may be used to analyze the corresponding relation of the sequences. After the adjustment is completed, the following two compares the information of the dot plot to confirm the portion existing in the gap in the self-dot plot of the reference genome in the self-dot plot of the assembly of the test sequence, preferably of the AK1 genome de novo assembly, to close or extend the gap. The gap can be used to identify structural variations by comparing the genomic sequence of the subject specimen as compared reference genome sequence or de novo assembled test sequence where gaps are solved.

In addition, the present disclosure provides a method for identifying a haplotype-type specific allele by comparing a reference genome and reconstructing a de novo assembly of a haploid using a phasing method.

Haplotig was produced through the following process. Illumina's Gemcode platform uses a bar-code primer and bead to PCR together with a single long DNA to generate a read by going through an amplification process in the form of possessing a barcode called GEM, and generate a pool. The reads in the pool share the same barcode if they are derived from the same GEM, which is called Linked Read. After performing de novo phasing with these linked reads and assembling into a contig to generate a haplotig (synthesis of haploid and contig), it can analyze the SV information. Through the analysis of SV information, it was compared with SV information of the previously known human reference genome.

It may be used as a method of identifying a gene variation comprising single nucleotide polymorphism (SNP), insertion deletion (indel) or structural variant (SV) on the genomic sequence of the subject specimen in comparison with the modified reference sequence and the de novo assembled test sequence according to the method of the present disclosure. In addition, it may be used as a method of identifying a gene variation comprising haplotype specific single nucleotide polymorphism (SNP), insertion deletion (indel) or structural variant (SV) in comparison with the genomic sequence information of the subject specimen by constituting a de novo assembly of haplotig of a test sequence so as to represent haplotype on a chromosome. Genetic information analysis based on the identification of these gene variations can be used to study the function of gene variations, in particular, to study the function of disease-associated gene variations, to diagnose diseases and to analyze expression of phenotypes. It can be used in the diagnosis and treatment of diseases through analysis of disease-related functions as one embodiment of genome information analysis and can be used in the development of personalized precision medical methods. As an additional embodiment, it can be used as a race-specific, in particular an Asian race-specific allele gene expression analysis method.

### EXAMPLE

Hereinafter, the present disclosure will be described in more detail with reference to examples. However, these examples are for illustrative purposes only, and the scope of the present disclosure is not limited to these examples.

### Example 1. AK1 Assembly

An embodiment implementing the procedure for obtaining the AK1 assembly used as the de novo assembled test sequence is provided as follows. The method of the following example was based on a thesis (Seo et al. 2016) incorporated into the reference in this application.

Preparation of AK1 Cell Line

An immortalized lymphoblastoid cell line was established from the AK1 individual through Epstein-Barr virus transformation of mononuclear cells (Seoul Clinical Laboratories Inc.). Full pathogen testing was performed and maintained in a mycoplasma-free facility. AK1 lymphoblastoid cell line was cultured in RPMI 1640 media containing 15% FBS at 37° C. in a humidified 5% CO₂ environment. The approval number C-0806-023-246 for the AK1 individual was assigned based on the guidelines from the Institutional Review Board of Seoul National University.

PacBio Data Generation

Genomic DNA was extracted from AK1 cells using the Gentra Puregene Cell Kit (Qiagen). Large-insert PacBio library preparation was conducted following the Pacific Biosciences recommended protocols. In brief, a total of 60 μg AK1 genomic DNA was sheared to ˜20 kb targeted size by using Covaris g-TUBEs (Covaris). Each shearing processed 10 μg input DNA and a total of 6 shearings were performed. The sheared genomic DNA was examined by Agilent 2100 Bioanalyzer DNA 12000 Chip (Agilent Technologies Inc.) for size distribution and underwent DNA damage repair/end repair, blunt-end adaptor ligation followed by exonuclease digestion. The purified digestion products were loaded onto pre-cast 0.6% agarose for 7-50 kb size selection using the BluePippin Size Selection System (Sage Science), and the recovered size-selected library products were purified using 0.5× pre-washed Agencourt AMPure XP beads (Beckman Coulter). The final libraries were examined by Agilent 2100 Bioanalyzer DNA12000 Chip for size distribution and the library concentration was determined with Qubit 2.0 Fluorometer (Life Technologies). We sequenced with the PacBio RSII instrument with P6 polymerase binding and C4 chemistry kits (P6C4). A total of 380 SMRT Cells were used to yield 101-fold whole-genome sequence data.

Sample Preparation for BioNano Genomics

AK1 cells were pelleted and washed with PBS; the final cell pellet was re-suspended in cell-suspension buffer using the CHEF Mammalian Genomic DNA Plug Kit (Bio-Rad). Cells were then embedded in CleanCut low-melt Agarose (Bio-Rad) and spread into a thin layer on a custom support (in development at BioNano Genomics). Cells were lysed using IrysPrep Lysis Buffer (BioNano Genomics), protease-treated with Puregene Proteinase K (Qiagen), followed by brief washing in Tris with 50 mM EDTA and then washing in Tris with 1 mM EDTA before RNase treatment with Puregene RNase (Qiagen). DNA was then equilibrated in Tris with 50 mM EDTA and incubated overnight at 4° C. before extensive washing in Tris with 0.1 mM EDTA followed by equilibration in NEBuffer 3 (New England BioLabs) at 1× concentration. Purified DNA in the thin layer agarose was labelled following the IrysPrep Reagent Kit protocol with adaptations for labelling in agarose. In brief, 1.25 μg of DNA was digested with 0.7 U Nt.BspQI nicking endonuclease per microlitre of reaction volume in NEBuffer 3 (New England BioLabs) for 130 min at 37° C., then washed with TE Low EDTA Buffer (Affymetrix), pH 8.0, followed by equilibration with 1× ThermoPol Reaction Buffer (New England BioLabs). Nick-digested DNA was then incubated for 70 min at 50° C. using the IrysPrep Labelling mix (BioNano Genomics) and Taq DNA Polymerase (New England BioLabs) at a final concentration of 0.4 U μl⁻¹. Nick-labelled DNA was incubated for 40 min at 37° C. using the IrysPrep Repair mix (BioNano Genomics) and Taq DNA Ligase (New England BioLabs) at a final concentration of 1 U μl⁻¹. Labelled-repaired DNA was then recovered from the thin layer agarose by digesting with GELase and counterstained with IrysPrep DNA Stain (BioNano Genomics) before data collection on the Irys System. The fragile site rescue process protects fragile sites by reducing the temperature of the labelling reaction and minimizes shear forces by restraining DNA in agarose until nicks are repaired. In this case, only the closest opposite-strand nick-pairs break.

Sequencing Library Preparation Using the GemCode Platform

Sample indexing and partition barcoded libraries were prepared using GemCode Gel Bead and Library Kit (10× Genomics). Sequencing was conducted with Illumina Hiseq2500 to generate linked reads.

Illumina Data Generation

Libraries were generated with PCR-free protocols. gDNA was sheared twice using Covaris S2 with cycling conditions of 10% duty cycle, Cycles/Burst 200, and Time 100 s. The sheared DNA was processed using the Illumina TruSeq DNA PCR-Free LT Library Kit protocol to generate 550 bp inserts, which includes end repair, SPRI bead size selection, A-tailing, and Y-adaptor ligation. Library concentration was measured by qPCR and loaded on HiSeq X Ten instruments (PE-150) to generate 72-fold sequence coverage.

DNA Preparation from BAC Clones

A total of 32,026 BAC clones were selected from the 252 384-well plates and re-plated into 96-well plates. Clones were grown overnight, and the cultures were used to prepare two additional replicates for the two 384-well plates that were stored at −80° C. in LB medium containing 20% glycerol. A total of 32,026 clone cultures with growth at ODs ranging from 0.6 to 1.0 were pooled, pelleted and the DNA was extracted using the standard alkaline lysis method. In this procedure, a cell pellet was resuspended in 150 μl of Qiagen buffer P1 with RNase and lysed with 150 μl of 0.2 M NaOH, 1% SDS solution for 5 min. Lysis was neutralized with the addition of 150 μl of 3 M sodium acetate, pH 4.8. Neutralized lysate was incubated on ice for 30 min, and DNA was collected by centrifugation for 15 min at 15.7 g at 4° C., concentrated by standard ethanol precipitation and resuspended in 25 μl of 10 mM Tris-HCl, pH 8.5.

PacBio Sequencing of BAC Clones

DNA from approximately 150 BAC clones with roughly equimolar concentration was combined into a single pool. A total of 10 μg from each pool DNA was sheared and fragments of insert size ranging from 10 to 15 kb were selected. Two libraries were prepared from the pooled DNA using a PacBio SMRTbell library preparation kit v 1.0. The libraries were quantified using a Qubit 2.0 fluorometer and each library was sequenced using two SMRT cells with P6C4 chemistry.

Illumina Sequencing of BAC Clones

DNA from approximately 290 BAC clones with roughly equimolar concentration was combined into a single BAC pool. One nanogram of DNA from each pool was digested and fragments of insert size ranging from 500 to 550 bp were selected. In total, 109 libraries were prepared from the pooled DNA using Illumina-compatible Nextera XT DNA sample prep kit and sequenced with HiSeq2500.

Sample Preparation for RNA Sequencing

The present inventors extracted RNA from tissue using RNAiso Plus (Takara Bio), followed by purification using RNeasy MinElute (Qiagen). RNA was assessed for quality and was quantified using RNA 6000 Nano LabChip on a 2100 Bioanalyzer (Agilent). The RNA sequencing (RNA-seq) libraries were prepared as previously described. RNA library was sequenced with Illumina TruSeq SBS Kit v3 on a HiSeq 2000 sequencer (Illumina) to obtain 100 bp paired-end reads. The image analysis and base calling were performed using the Illumina pipeline with default settings.

Sample Preparation for Isoform Sequencing

Total RNA extracted from AK1 cells with RNA integrity number (RIN)>8.0 was used for library preparation. The library was constructed following the Clontech SMARTer-PCR cDNA Synthesis Sample Preparation Guide. 1-2 kb, 2-3 kb, 3-6 kb and >5 kb libraries were selected by Sage, ELF purified, end-repaired and blunt-end SMRTbell adapters were ligated. The fragment size distribution was confirmed on a Bioanalyzer HS chip (Agilent) and quantified on a Qubit fluorometer (Life Technologies). The fragment size distribution was validated on a Bioanalyzer HS chip (Agilent) and quantified on a Qubit fluorometer (Life Technologies). The sequencing was carried out on the PacBio RSII instrument using P6C4.

PacBio Lone-Read De Novo Assembly

Around 31 million subreads were used for assembly with FALCON v0.3.0 given length_cutoff parameter of 10 kb for initial mapping to build pre-assembled reads (preads), and preads over 15 kb (length_cutoff_pr) were used to maximize the assembled contig N50. Primary and associated contigs were polished using Quiver5.

BioNano Genomics Genome Map Generation

Optical maps were de novo assembled into genome maps using BioNano assembler software (Irys System, BioNano Genomics). Single molecules longer than 150 kb with at least 8 fluorescent labels were used to find possible overlaps (P<1×10⁻¹⁰). Next, these maps were constructed to consensus maps by recursively refining and extending them by mapping single molecules (P<1×10⁻⁵). The consensus maps were compared and merged into genome maps when patterns matched (P<1×10⁻¹⁰). A second set of optical maps was obtained thereafter, and generated into genome maps with the same criteria.

Contig Editing and Hybrid Assembly

Primary contigs were in silico digested into cmaps and were compared with genome maps for scaffolding. The scaffolding was visualized and performed with the Irys Viewer. When conflict occurred, the contigs were edited with the guidance of genome map.

Assembly Improvements

Paired-end reads from Illumina platform were aligned to the assembly using bwa mem, followed with duplication removal using Picard tools. Base-pair correction of the assembly was performed using Pilon. Pilon mostly corrected single insertions and deletions in regions enriched with homopolymer. Contigs or scaffolds shorter than 10 kb were excluded from the overall analysis to avoid results from spurious misassembly.

Scaffold Accuracy Measurement with BAC Clones

Scaffolding accuracy of the AK1 assembly was assessed using the AK1 BAC library. AK1 BAC end sequences (BES) were aligned to GRCh37, GRCh38 and AK1 assemblies using BWA. The BES placements were categorized by the alignment, orientation and separation of BES with respect to the assembly. The BES placement was determined to be concordant: (1) if the BES placement was placed in the same assembly unit; (2) if the paired end sequences were properly oriented; and (3) if the in silico insert size was between 50,000 and 250,000 bp. If the BES placements did not meet these conditions, the BES placement was defined to be discordant. In addition, if only one of the paired end sequences were aligned to the assembly, the BES placement was defined to be an orphan placement. If both paired-end sequences were unaligned to the assembly, the BES was defined to be unmapped. If either of the paired-end sequences were aligned to different positions of the assembly multiple times, the BES was defined to have multiple placements.

### Example 2. Modification of Reference Genome Information Using Multiple Dot Plot

Gap Closure and SV Analysis: Alignment to the Reference Genome

To identify the precise genomic location of each assembly unit, we used LASTZ with parameters (−gapped-gap=600, 150, −hspthresh4500, −seed=12 of 19-notransition-ydrop=15000-chain) to align each assembly unit to each chromosome in the human reference genome. Chaining procedure was followed to join the neighbouring local alignments into a single cohesive alignment. The chained alignments of each assembly unit were processed to obtain a single alignment with the best alignment score. If the selected alignment was not fully representative of the assembly unit, we selected a set of alignments that was better representative of the assembly unit. A netting procedure was then followed with the selected chained alignments. The chaining and netting procedures were applied using UCSC Kent tools and parallel processing was used when possible to increase computational speed.

Gap Closure of GRCh38

Gaps were classified into telomeric, centromeric, heterochromatic, acrocentric and euchromatic region according to the agp file and cytoband information provided by the Genome Reference Consortium (GRC) and UCSC genome browser. In total, 190 euchromatic gaps were targeted for gap closure with AK1 assembly. The gaps that could not be closed or extended with the AK1 assembly were subjected to closure through local assembly using Canu or a contiguous subread. Subreads mapped 10 kb upstream or downstream of the gap were chosen for local assembly. Alignment was performed with BLASR-bestn 3, and primary aligned reads with mapping quality of 254 were used. The assembled contigs were thereafter aligned to their respective gap position to precisely identify the added sequences. Subreads used to close the gaps were chosen following criteria described in the Supplementary Information.

Selection of Sub-Reads for Gap Closing

The initial set of 190 euchromatic gaps was targeted for gap closure. Using the AK1 assembly alignment, non-overlapping best alignments of chains spanning a gap region were chosen as candidates for closure or extension. We defined a criterion for ‘a gap is spanned’ as follows:

For autosomes: 0.8×S≤L≤1.2×S

For allosomes: 0.5×S≤L≤1.5×S

Where S is the size of the mapped length obtained by subtracting the starting coordinate from ending coordinate of GRCh38, and L is the length of the corresponding scaffold.

To avoid misalignments due to repetitive regions around the gap, subreads were filtered by its mapping quality and the one with best identity to the bases around the gap was selected to close or extend the gap. The identity was calculated by:

Identity=no. of matched bases with no mismatches/no. aligned bases

The bases for extending into the gap was obtained when the subread with best identity only when qualifying the criterion as follows:

Soft-clipped bases/Matched sequence over gap flanking region<1

Preparation of AK1 Assembly Self-Dot Plot and Reference Genomic Self-Dot Plot

Using the sequence information of the de novo assembled AK1 assembly through the method of Example 1, the self-dot plot of the genome was prepared as follows.

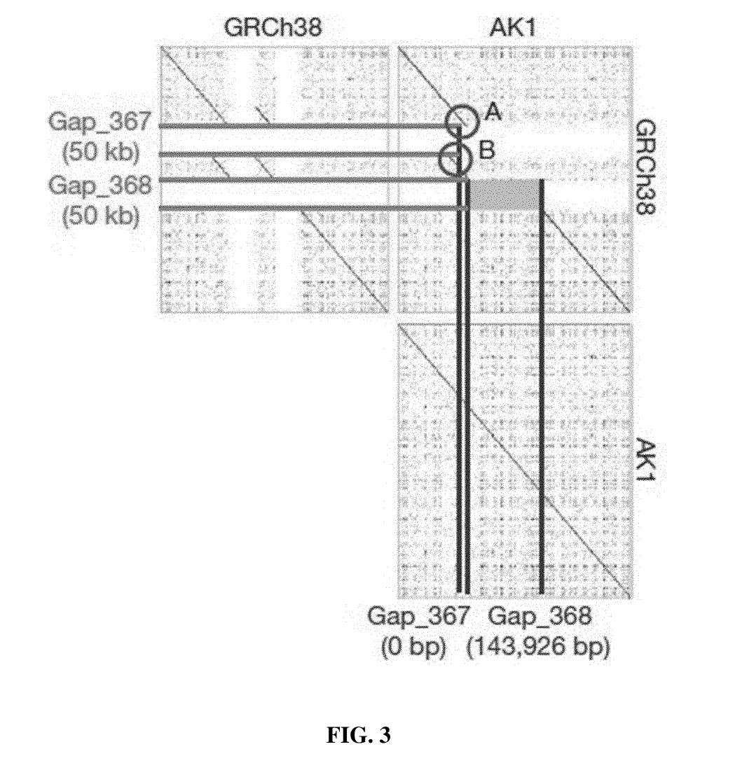

The sequence information of AK1 of the selected chromosomal location (a part of the chromosome 1-23) is arranged on one axis (x-axis) of the dot plot, reflecting position (bp unit) information, and the same sequence information is arranged on the other axis (y-axis). Comparing two information with coordinates, the part where the gap is present (the point is not drawn if the sequence is represented by N because there is no sequence information) and the filled part (when the sequence information is present and the sequence is indicated by A, G. C and T, a dot is marked) are displayed. In the same manner, the reference genome (GRCh38) information of the chromosome position such as the chromosome position where the sequence information of AK1 was prepared is arranged together with the position information on the two coordinate axes, and the portion where the gap is present and the portion where the sequence is filled are displayed and arranged (FIG. 3).

AK1 Assembly Self-Dot Plot and Reference Genome Self-Dot Plot are Placed on One Screen to Provide Gap Closing or Gap Extension

FIG. 2 illustrates that the result of comparison and analysis with the AK1 scaffold is supported by the BAC information when correcting the existing gap information of the reference genome. The sequence information of gaps Gap_367 and Gap_368 existing on the existing reference was modified through the same contig assembly information of AK1. Gap_367 was known to be 50 kb on the existing reference genome, but was reduced to 0 kb when compared to the AK1 assembly. Gap_368 is known as 50 kb, but compared to the AK1 assembly, it was actually 144 kb long. The position information of the gap was confirmed by referring to the scaffold of AK1 containing the reads obtained from the BAC clone of BAC_154-H07 and BAC_168-G09.

FIG. 3 is an illustration of a method for modifying gap information by comparing a reference genome with a de novo assembled AK1 assembly using a multiple dot plot. Using the self-dot plot, the sequence region covering the existing gaps Gap_367 and Gap_368 of the reference genome (GRCh38) is visualized in the upper left dot plot (Reference-Reference), and the self-dot plot of the sequence corresponding to the same position of the AK1 assembly is arranged in the right bottom (AK1-AK1).

One dot plot where AK1 and the reference genome are plotted on the respective axes is added (Reference-AK1), the position where the gap occurs in each of the self-dot plots is visually displayed differently. When the starting point A of Gap_367 of the reference genome and the end point B are indicated by the coordinates corresponding to the axis of dot plot of AK1, they are marked at the same position. The gap appeared by 50 kb in the reference genome Gap_367 appears as 0 bp and the gap is closed. In the same way, when the information of the reference genome Gap_368 is modified, a coordinate value showing a difference larger than the interval difference of the reference genome is rather obtained. By identifying that the gap has a size of 143,926 bp instead of a size of 50 kb, the gap is extended. The positions of these gaps have successive repeating sequences as reported previously, and this was a region that cannot be identified by the method using only the conventional short read.

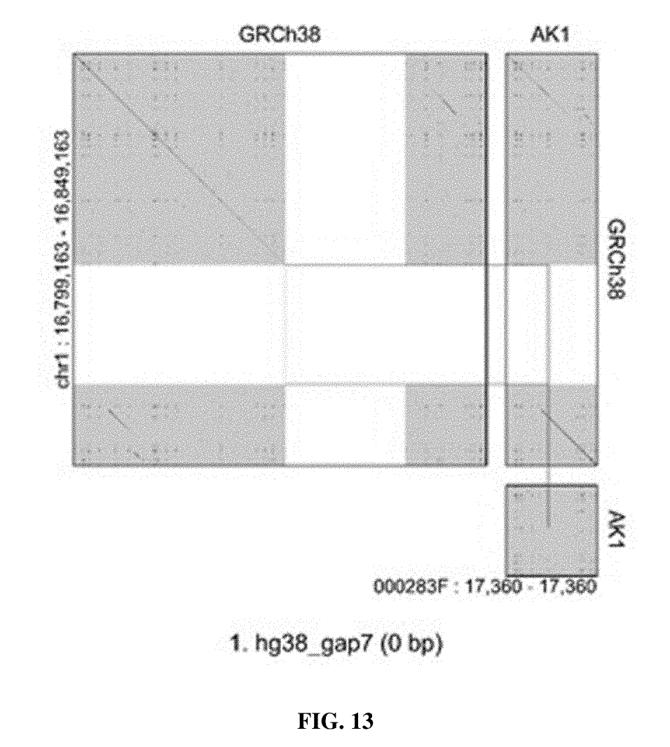

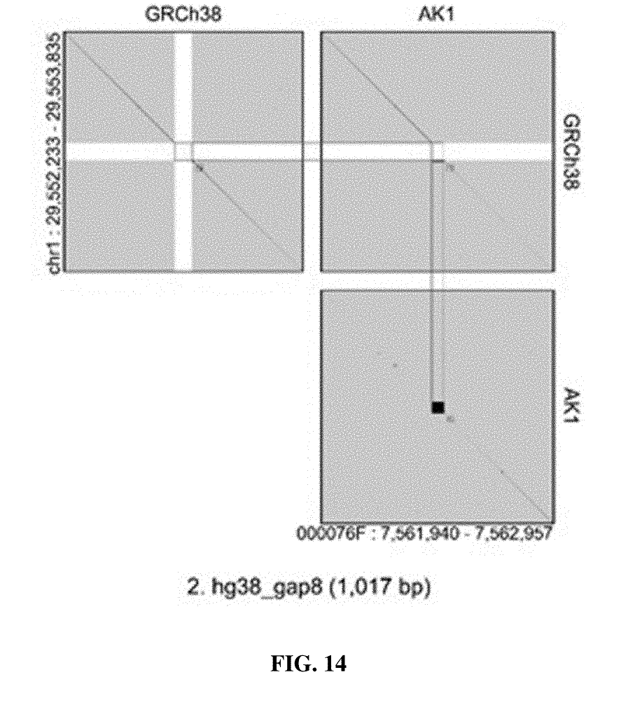

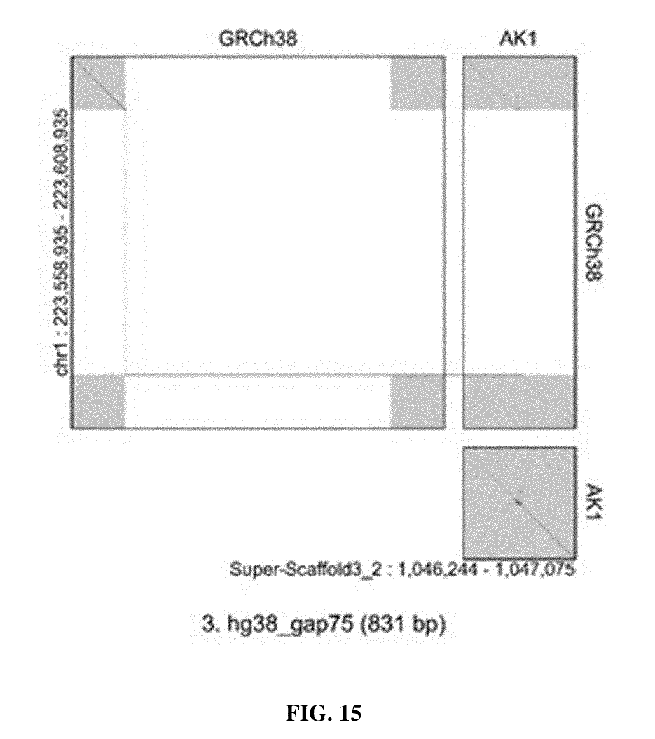

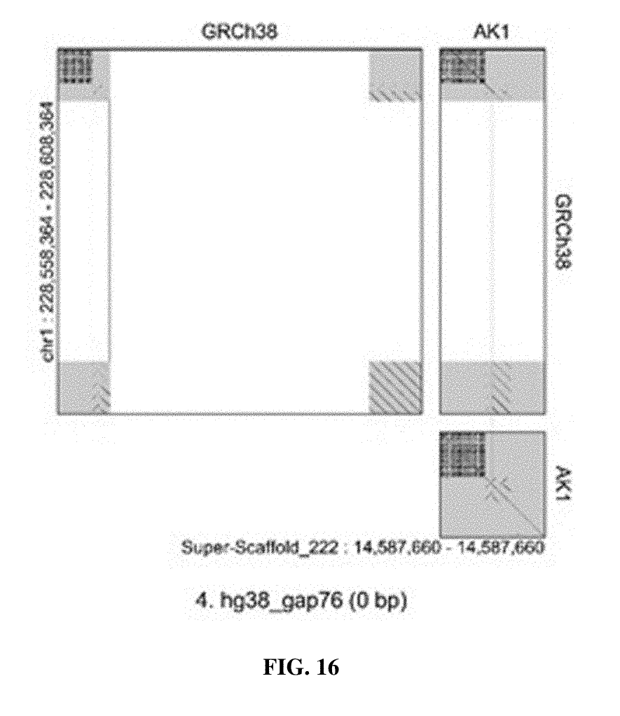

FIGS. 13 to 16 illustrate the results of modifying the gap information existing in the reference sequence by comparing the reference genome with the de novo assembled AK1 assembly using the multiple dot plot in the same manner.

Gap Closing Result of Reference Genome Structure

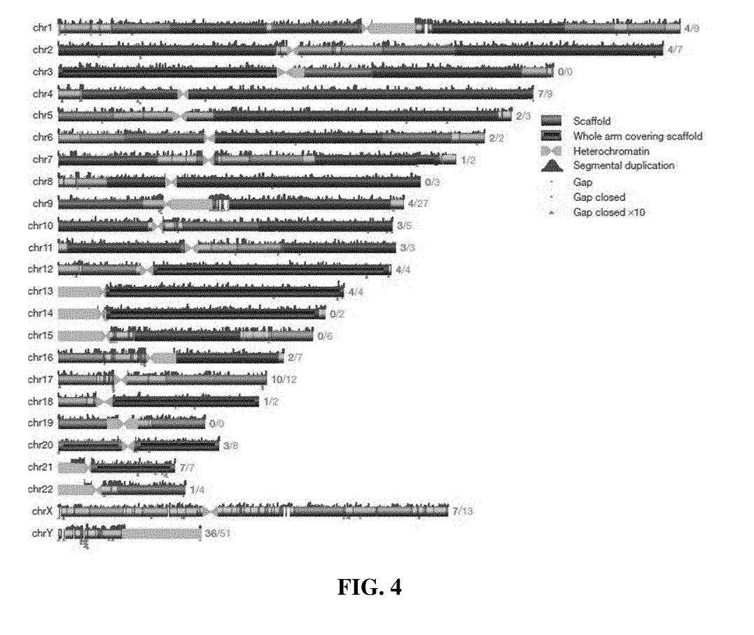

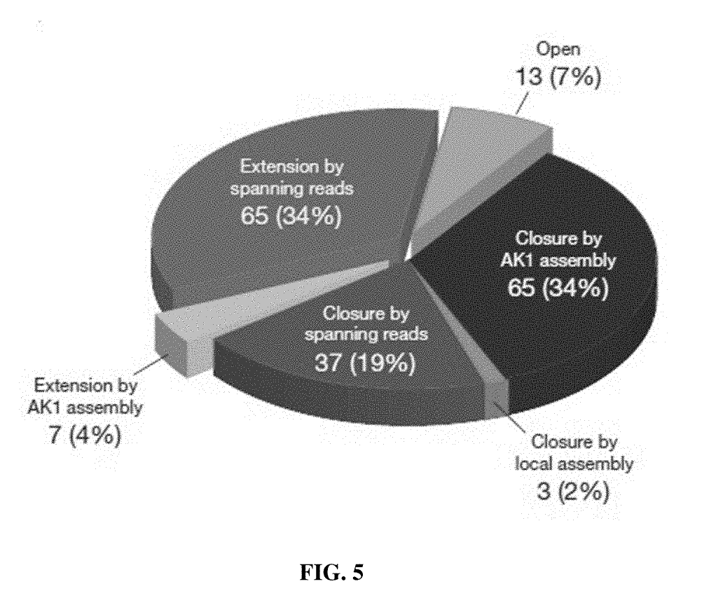

The multiple dot plot performed according to the above method could be used to align the existing reference genome assemblies and de novo genome assemblies and then to perform a gap closure of the existing reference genomic structures (FIG. 4). The inventors of the present disclosure closed 65 out of 190 euchromatic gaps in the GRCh38 reference (FIG. 5). In addition, the use of local realignment or reassembly, or spanning reads allowed to close 40 gaps.

FIG. 4 illustrates the scaffold coverage of each chromosome in the AK1 assembly as compared to GRCh38. The final assembly after polishing exhibits contiguity that has not been achieved by non-reference assemblies of the human diploid genome so far. The largest 91 scaffolds, for example, cover 90% of the genome and 8 chromosomal arms are spanned by single scaffolds. The euchromatic gaps closed on each chromosome are indicated in red, and the total number of gaps is indicated in gray.

FIG. 5 illustrates the number of gaps (blue) closed with AK1 assembly in the present disclosure, the number of gaps closed by the local assembly of long reads (light blue), and the number of gaps closed by long read only (red). It also illustrates the number of gaps (yellow) extended to the AK1 assembly, the number of gaps extended to the long read (green), and the open gap (gray).

Table 1 below exhibits the differences between the human reference genome GRCh38 and the de novo assembled AK1 assembly in the present disclosure.

TABLE 1

| | AK1 | GRCh38 |
|---|---|---|
| Assembly method | WGS and BAC | BAC and fosmid |
| Sequencing and physical | PacBio and | Sanger, FISH, OM and |
| mapping | BioNano | fingerprint contig |
| De novo assembly algorithm | FALCON | Numerous methods |
| Phasing method | De novo | NA |
| Scaffold/Contig N50 (Mb) | 44.85/17.92 | 67.69/56.41 |
| Scaffold/Contig L50 | 21/50 | 16/19 |
| Length of total gap (Mb) | 2,832/4,206 | 735/1,385 |
| Number of gaps | 264* | 999** |
| total number of bases among | 2,904,207,288/ | 159.97 |
| assemblies/non-N base (bp) | 2,866,687,809 | |
| Phased block N50 (Mb) | 11.55 | 3,209,286,105/ |
| | | 3,049,316,098 |
| Number of haplotigs | 18,964 | NA |
| Haplotigs N50 (kb) | 875 | NA |
| Total haplotigs (bp) | 4,804,460,182 | NA |

*Number of the spanned gaps
**Number of the spanned gaps and non-spanned gaps

As described above, it can be seen that the information of the existing reference genome reference can be modified through the genetic information providing method according to the present disclosure and can be utilized for modification of various reference information including humans, and it is expected to develop a system for providing accurate genetic information of an organism.

In addition, the conventional human reference genome does not include the genome information of Asian races and is deficient in providing information on racial diversity. With AK1 used in the present disclosure, it is also possible to provide a highly diversified reference genome including Asians, which is expected to be useful for genetic-related diseases or genetic characteristic study involving Asians as an object.

### Example 3. Analysis of SV

Assembly Based SV Detection

The alignments of the assembly to the reference genome were parsed to obtain SNPs, indels and SVs, which we defined as insertion, deletion, inversion and complex variants with event size equal to or greater than 50 bp. The complex SVs are the same as ‘double-sided insertion’ defined previously. We used GRCh37 instead of GRCh38 for the main analysis for compatibility and comparison with previously reported structural variations.

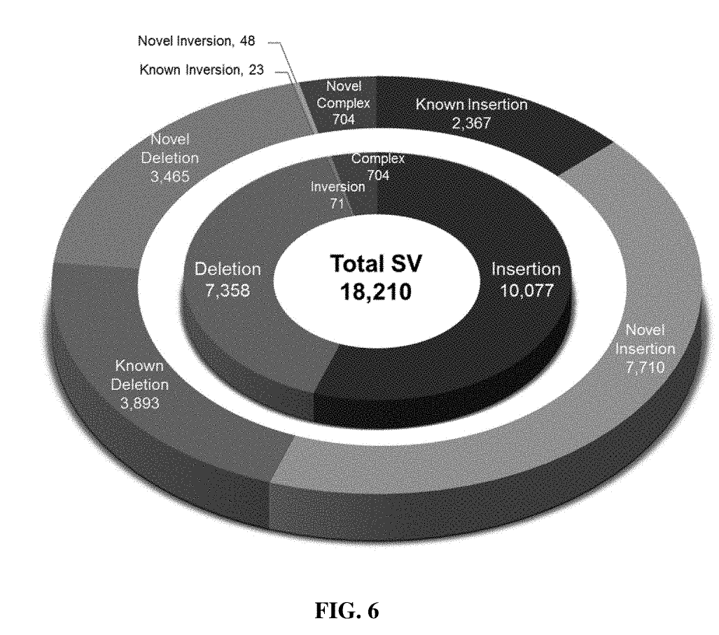

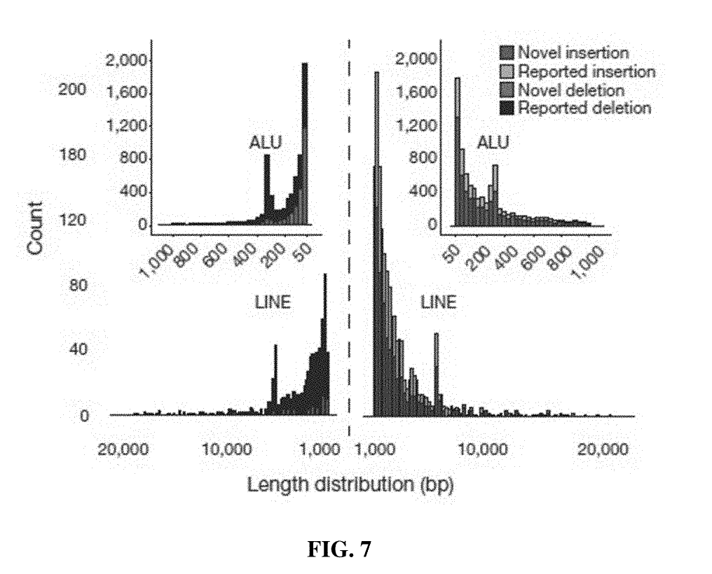

FIG. 6 is a pie chart analyzing the overall distribution of SV through a direct comparison of the AK1 assembly with the GRCh37 reference genome. Deletion (red), insertion (blue), inversion (green), and complex (grey) variants were detected. Outer pie chart represents new variants for each SV types. In total, 18,210 structural variants (SVs) were identified, including 7,358 deletions, 10,077 insertions, 71 inversions, and 704 complex variants. Compared to previous studies, a total of 11,927 variants were new variants that were previously unreported. Of the new SVs, 86% were highly enriched for clusters of mobile and tandem repeats (FIG. 7).

Analysis results of the insertion variants exhibited that the AK1 sequence consists of repeats and duplications as well as unique sequences that are not present in the reference genome. To investigate whether unique sequences are universal or race-specific, raw reads in the High Coverage 1000 Genome Project sample, additional high-coverage Asian samples were compared and aligned with the AK1 assembly, and compares read depths normalized in four racial groups.

Population allele frequency of SVs was obtained by aligning reads from 38 high-coverage samples from five different ancestral backgrounds (African, American, European, East Asian, and South Asian) to the AK1 assembly. We obtained whole-genome sequencing data of 23 individuals from the 1000 Genomes Project and we additionally sequenced 15 East Asian individuals (5 Japanese, 5 Chinese and 5 Koreans). Analysis candidates were selected from the insertions with less than 70% of repeats. We excluded any duplications among the insertions that are mapped to GRCh37 using BLAST (−evalue 1e-10-perc_identity 90-qcov_hsp_perc 90). The regions that have been recognized as mobile element or tandem repeat by RepeatMasker and TRF softwares were masked for analysis. Normalized read depth within the unique sequence was achieved by dividing the read depth, which was calculated using samtools bedcov, by the median genome coverage. The insertions were determined to be highly polymorphic if there were greater than or equal to 0.3 variant frequency differences across the different populations. Asian-specific insertions were chosen by selecting the insertions with equal or above 0.3 allele frequency difference between Asian and non-Asian population as well as non-Asian allele frequency with equal or below 0.5. Asian linkage disequilibrium blocks were obtained from East Asian samples in the 1,000 Genomes Project phase 3 using S-MIG++algorithm (−maf 0.05-ci AV-probability 0.95). Linkage disequilibrium blocks with below 0.8 haplotype diversity index were excluded.

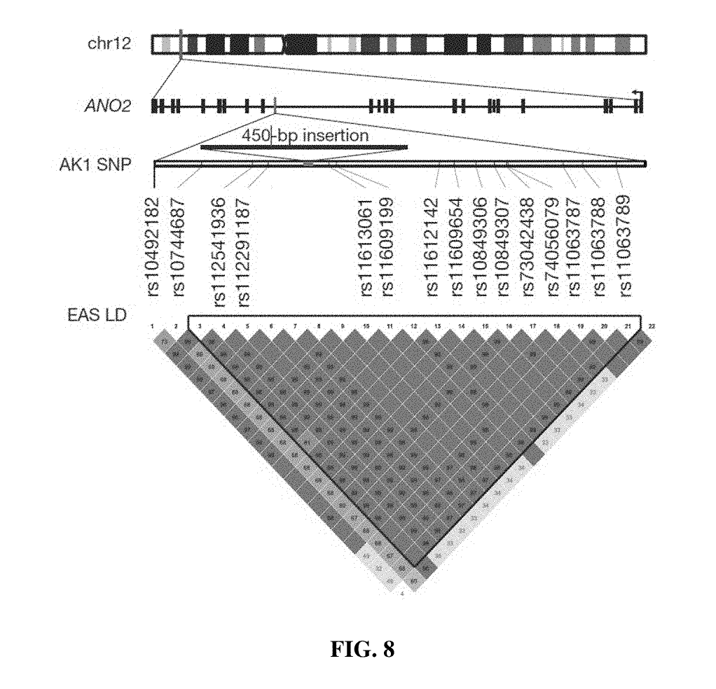

Out of 853 insertions, encompassing 1.7 Mb, which were found in all of the ancestral groups, 800 insertions were also called from the variant analysis with respect to GRCh38, and as such are candidates for addition to the human reference genome. Moreover, 400 insertions showed highly polymorphic frequency variability across the populations, and 76 of them, including 45 genic insertions, were Asian specific (FIG. 8). Among the genic insertions, the present inventors found that a 592-bp insertion within POU2F3, reported to have distinctly variable haplotype frequencies among populations, was comprised of 452 bp of unique sequence between two 140-bp duplications. We also identified numerous large insertions with higher frequency in the Asian population, such as a 4,539-bp insertion in HRASLS2 (FIG. 8).

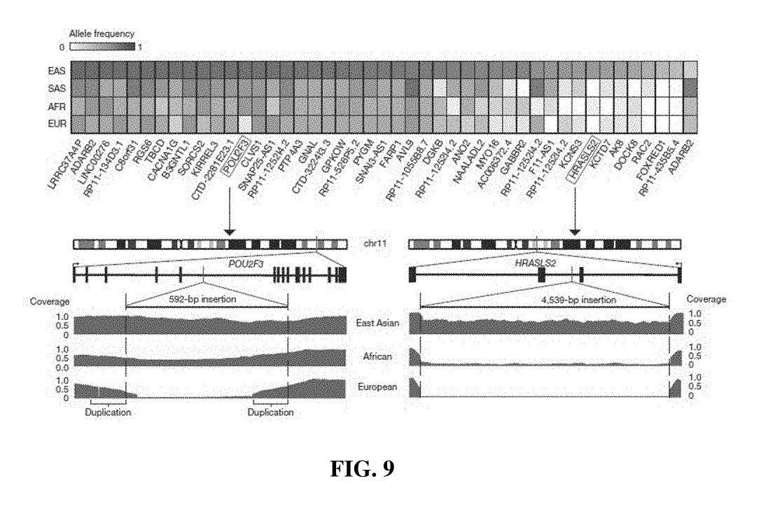

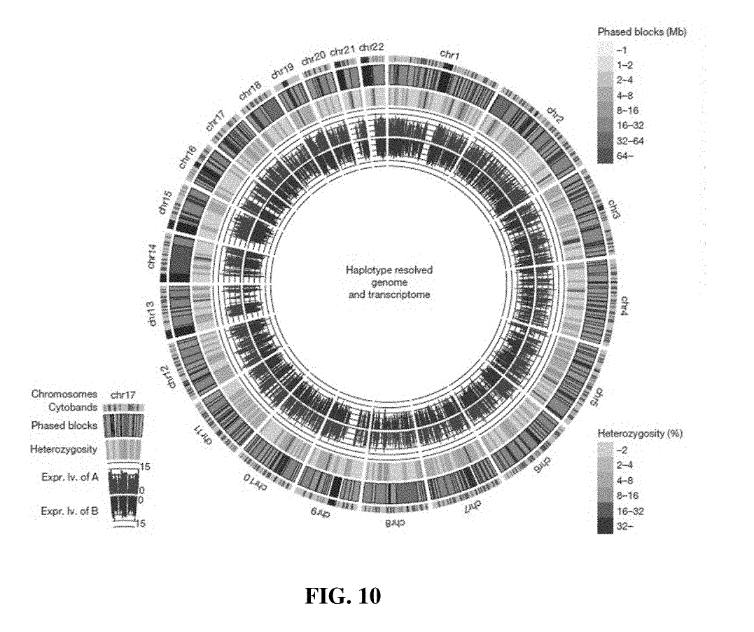

Next, the present inventors investigated the haplotype structures associated with Asian-specific variants by using linkage disequilibrium blocks inferred from 1000 Genomes Project Asian samples. Among the variants, 39 insertions were present within the blocks, and 82% of them were located on the same block as a homozygous AK1 SNP. One of the insertions, found within ANO2, had a similar allele frequency with adjacent homozygous AK1 SNPs within the same linkage disequilibrium block (FIG. 9). The findings demonstrate the important genomic differences of Asian ancestral group from the others, and highlight the need for further genomic studies focused on individuals outside of European ancestry to describe the variations in humans.

SV Annotation

Repeat elements were annotated using RepeatMasker (−species human-no_is) and tandem repeat finder (TRF) (2 7 7 80 10 50 2000-f -m-h-d). SVs are classified accordingly if it is masked by at least 70% with a single type. Complex is defined as the SVs having either several annotated repeat elements, or at least 30% of the remaining sequence not annotated as repeat. Novelty was identified by comparing the breakpoints with 50% reciprocal overlap criterion. Functional annotation was performed using both GENCODE release v19 (GRCh37) and v21 (GRCh38) and the Ensemble Regulatory Build. For those SVs that occurred within gene regulatory domains, we annotated with the nearest gene name. SV located within pericentromeric regions (5 Mb flanking annotated centromeres) and subtelomeric regions (150 kb from the annotated telomeric sequence) were annotated as heterochromatin. Both pilot and strict accessibility genome mask regions (version 20141020) were downloaded from ftp://ftp.1000genomes.ebi.ac.uk/vol1/ftp/release/20130502/supporting/accessible_genome_mask s/.

Segmental duplication sites were downloaded from the UCSC table browser. To simplify categorization of the SVs that lie within multiple functional regions, they were classified according to the order of priority as follow: coding sequence, untranslated region, intron, transcription-factor-binding site, promoter, enhancer, CTCF (transcriptional repressor), and intergenic. To annotate whether the SVs called from GRCh37 were also shared with GRCh38 SV sets, we compared each AK1 breakpoints with 50% reciprocal overlap criterion. In addition, we assessed whether the SVs called from GRCh38 were also represented in the alternative contigs by measuring the concordance against the SV regions including the surrounding 50 bp from the breakpoints.

De Novo Phasing Markers

The present inventors performed phasing (work to identify sequence-derived maternal line or paternal line) against the de novo assembly. Phasing was performed with PacBio long reads, Illumina short reads, 10× Genomics linked reads4 (30×), and reads from BACs representing a single haplotype (47×). Heterozygous SNVs called from these methods are assigned to two phases, producing phased blocks with an N50 length of 11.6 Mb, considerably longer than previously reported (Table 1).

SNPs and short indels called from whole-genome sequencing (72×) of short reads were phased with linked reads. The non-redundant set of PacBio subreads were aligned to the assembly, and corrections were applied by calculating the maximum likely variant allele for the phased variants based on the read depth. A phased block was defined as the region spanning two markers which had a subread or linked read information providing phasing. Similar to the linked reads, Illumina sequenced BAC phase information was used to correct phasing markers and extend phased blocks.

Switch Error of Phasing Markers

The present inventors assessed the accuracy of the phased blocks against the end sequences of BACs, and found a long-range switch error rate to be under 0.3%.

The end sequences were aligned to the AK1 assembly with bwa mem, and the base allele of the phasing marker site was called with the corresponding BAC information. When switching occurred for more than two marker sites in a phased block, it was defined as a long range switch. The long-range switch error rate was calculated as: no. of long range switches/no. of phasing markers.

Haplotig Assembly

The SMRT reads were then distributed to two phases with a sufficient number of marker SNVs. The two sets of dispensed reads were assembled into a de novo to produce a haplotig. Using the final set of phasing markers, subreads were classified into sets of haplotype A or B when >85% of the phasing markers agreed. When a subread contained no marker, it was classified as homozygous. Through the read depth, phasing markers that were missed in previous steps were additionally called for homozygous regions adjacent to phased blocks. Subreads in haplotype A or homozygous regions were assembled into haplotig A, and haplotype B into haplotig B with Canu. In this case, subreads phased (determined to be derived from haploid) as homozygous were used with subreads of haplotype A and B. Homozygously phased subreads flanked on each side of a sequencing gap belonged on haplotype A and B, respectively, and were re-classified during assembly.

Determination of SV Effectiveness of the De Novo Assembly and SV of the BAC Clones

Comparison of the haplotigs to the human reference genome led to identification of haplotype-specific alleles including SNPs, short indels and SVs (Table 2).

TABLE 2
Number of variants phased on an autosome

| | SNPs | | INDELs | | SVs | |
|---|---|---|---|---|---|---|
| | Het | Hom | He | Hom | Het | Hom |
| chr1 | 153,853 | 124,818 | 7,358 | 6,514 | 1,863 | 323 |
| chr2 | 159,672 | 133,893 | 7,721 | 6,941 | 1,880 | 323 |
| chr3 | 128,221 | 114,943 | 5,972 | 5,728 | 1,495 | 265 |
| chr4 | 138,860 | 120,254 | 6,695 | 5,856 | 1,658 | 234 |
| chr5 | 120,983 | 91,714 | 5,303 | 4,712 | 1,301 | 216 |
| chr6 | 129,980 | 101,781 | 6,106 | 5,162 | 1,470 | 295 |
| chr7 | 114,395 | 87,045 | 5,255 | 4,610 | 1,782 | 294 |
| chr8 | 111,101 | 77,958 | 4,555 | 3,586 | 1,209 | 224 |
| chr9 | 89,046 | 64,945 | 3,842 | 3,009 | 1,088 | 200 |
| chr10 | 94,171 | 75,201 | 4,370 | 3,806 | 1,252 | 209 |
| chr11 | 92,486 | 78,056 | 4,191 | 4,007 | 1,167 | 202 |
| chr12 | 94,828 | 75,902 | 4,689 | 4,139 | 1,225 | 232 |
| chr13 | 70,731 | 64,056 | 3,272 | 3,342 | 989 | 173 |
| chr14 | 68,444 | 47,451 | 3,147 | 2,471 | 671 | 102 |
| chr15 | 54,878 | 46,343 | 2,550 | 2,531 | 664 | 122 |
| chr16 | 62,360 | 44,862 | 2,714 | 2,088 | 844 | 115 |
| chr17 | 49,833 | 39,326 | 2,573 | 2,330 | 933 | 172 |
| chr18 | 54,672 | 46,805 | 2,604 | 2,413 | 756 | 133 |
| chr19 | 49,278 | 29,131 | 2,596 | 1,759 | 923 | 137 |
| chr20 | 42,647 | 31,038 | 1,981 | 1,633 | 651 | 121 |
| chr21 | 28,924 | 20,578 | 1,361 | 1,448 | 482 | 81 |
| chr22 | 28,340 | 18,773 | 1,268 | 1,106 | 593 | 65 |
| Total | 1,937,703 | 1,534,873 | 90,123 | 79,191 | 24,896 | 4,238 |

In addition to the SVs called from the assembly, 13,436 heterozygous haplotype-specific SVs were identified from haplotigs. The present inventors tested the accuracy of these SVs against BAC contigs on the same phase, and found that 67 out of the 69 that could be assessed matched perfectly (Table 3).

TABLE 3
Phase-specific SVs identified by BAC

| | | | | | SV_ID (Haplotig | | BAC |
|---|---|---|---|---|---|---|---|
| Chr | Start | End | Type | Phase | position) | Identity | Consensus |
| chr1 | 113,958,943 | 113,958,943 | INS | A | A_01550005_005:965 | Perfect | tig00002142 |
| | | | | | 70-96835 | match | |
| chr1 | 246,989,196 | 246,989,257 | DEL | A | A_00850001_001:536 | Perfect | tig00000198 |
| | | | | | 877-536877 | match | |
| chr2 | 98,582,146 | 98,582,146 | INS | A | A_00730005_006:525 | Perfect | tig00000392 |
| | | | | | 155-525459 | match | |
| chr2 | 119,652,804 | 119,652,804 | INS | B | B_01630002_002:760 | Perfect | tig00000221 |
| | | | | | 84-76195 | match | |
| chr4 | 1,357,963 | 1,358,091 | DEL | A | A_00790001_001:219 | Perfect | tig00000581 |
| | | | | | 9723-2199723 | match | |
| chr4 | 1,391,891 | 1,392,161 | DEL | A | A_00790001_001:216 | Perfect | tig00000581 |
| | | | | | 4750-2164750 | match | |
| chr4 | 1,421,173 | 1,421,173 | INS | A | A_00790001_001:213 | Perfect | tig00000581 |
| | | | | | 4820-2135686 | match | |
| chr5 | 180,473,219 | 180,473,219 | INS | A | A_00870001_013:252 | Reasonable | tig00000671 |
| | | | | | 762-253831 | match | |
| chr6 | 31,274,795 | 31,274,929 | DEL | B | B_00400065_003:806 | Perfect | tig00000117 |
| | | | | | 4-8064 | match | |
| chr6 | 31,288,028 | 31,288,262 | DEL | B | B_00400066_001:195 | Perfect | tig00000559 |
| | | | | | 87-19587 | match | |
| chr6 | 31,296,782 | 31,296,782 | INS | A | A_00400001_001:122 | Perfect | tig00000559 |
| | | | | | 2942-1223286 | match | |
| chr6 | 31,297,394 | 31,297,394 | INS | A | A_00400001_001:122 | Perfect | tig00000559 |
| | | | | | 1538-1222326 | match | |
| chr7 | 91,214,216 | 91,220,724 | DEL | A | A_00370008_002:119 | Perfect | tig00000431 |
| | | | | | 8113-1198113 | match | |
| chr7 | 142,098,198 | 142,276,193 | COMPLEX | A | A_01470003_003:516 | Perfect | tig00000418 |
| | | | | | 785-707087 | match | |
| | | | | | | (Half | |
| | | | | | | covered) | |
| chr8 | 40,748,795 | 40,748,795 | INS | A | A_01790003_041:805 | Perfect | tig00000737 |
| | | | | | 96-80651 | match | |
| chr8 | 58,127,808 | 58,127,808 | INS | B | B_01790055_010:237 | Perfect | tig00000614 |
| | | | | | 05-29088 | match | |
| chr8 | 58,129,671 | 58,129,671 | INS | B | B_01790055_010:309 | Perfect | tig00000614 |
| | | | | | 27-36248 | match | |
| chr8 | 58,132,170 | 58,132,170 | INS | B | B_01790055_010:387 | Perfect | tig00000614, |
| | | | | | 59-41799 | match | tig00000617 |
| chr8 | 58,133,432 | 58,133,447 | COMPLEX | B | B_01790055_010:430 | Perfect | tig00000614 |
| | | | | | 74-44511 | match | |
| chr8 | 58,134,140 | 58,134,162 | COMPLEX | B | B_01790055_010:452 | Perfect | tig00000614 |
| | | | | | 24-49532 | match | |
| chr8 | 144,744,161 | 144,744,161 | INS | B | B_00010011_001:639 | Perfect | tig00000658 |
| | | | | | 09-64545 | match | |
| chr8 | 144,744,161 | 144,744,161 | INS | B | B_00010011_001:639 | Perfect | tig00000658 |
| | | | | | 09-64545 | match | |
| chr8 | 144,744,421 | 144,744,421 | INS | B | B_00010011_001:630 | Perfect | tig00000658 |
| | | | | | 71-63649 | match | |
| chr8 | 144,749,197 | 144,749,247 | DEL | B | B_00010011_001:583 | Perfect | tig00000658 |
| | | | | | 16-58316 | match | |
| chr9 | 72,092,330 | 72,121,287 | DEL | B | B_01450125_001:229 | Perfect | tig00002138, |
| | | | | | 057-229057 | match | tig00002139, |
| | | | | | | | tig00002141 |
| chr9 | 73,322,438 | 73,340,431 | DEL | A | A_01450002_003:886 | Perfect | tig00000079 |
| | | | | | 988-886988 | match | |
| chr10 | 124,440,913 | 124,440,913 | INS | A | A_01800001_005:119 | Perfect | tig00000028 |
| | | | | | 801-119978 | match | |
| chr11 | 980,298 | 980,298 | INS | A | A_00970002_002:587 | Perfect | tig00000703 |
| | | | | | 698-588127 | match | |
| chr11 | 1,017,240 | 1,017,240 | INS | B | B_00970005_001:628 | Perfect | tig00000550 |
| | | | | | 9-7965 | match | |
| chr11 | 93,154,136 | 93,160,197 | DEL | B | B_01000047_001:358 | Perfect | tig00000407 |
| | | | | | 749-358749 | match | |
| chr17 | 225,442 | 225,496 | DEL | B | B_00490012_006:377 | Perfect | tig00000486 |
| | | | | | 98-37798 | match | |
| chr19 | 2,131,645 | 2,131,645 | INS | B | B_00670013_001:278 | Perfect | tig00000482 |
| | | | | | 68-27922 | match | |
| chr19 | 2,200,975 | 2,201,029 | DEL | A | A_00670001_003:176 | Perfect | tig00000482 |
| | | | | | 148-176148 | match | |
| chr19 | 8,349,945 | 8,364,794 | DEL | A | A_00670001_002:122 | Perfect | tig00000303 |
| | | | | | 8743-1228743 | match | |
| chr19 | 9,322,407 | 9,322,407 | INS | A | A_00080001_001:459 | Perfect | tig00000355 |
| | | | | | 699-459768 | match | |
| chr19 | 40,373,874 | 40,389,581 | DEL | B | B_01720013_001:112 | Perfect | tig00000650, |
| | | | | | 919-112919 | match | tig00000668 |
| chr20 | 1,592,433 | 1,592,433 | INS | A | A_01370001_002:110 | Perfect | tig00000000 |
| | | | | | 7999-1108163 | match | |
| chr20 | 1,778,684 | 1,778,684 | INS | B | B_01370008_001:494 | Perfect | tig00000532 |
| | | | | | 95-49609 | match | |
| chr20 | 1,857,765 | 1,857,765 | INS | B | B_01370008_001:128 | Perfect | tig00000611 |
| | | | | | 670-137880 | match | |
| | | | | | | (Half | |
| | | | | | | covered) | |
| chr20 | 4,399,805 | 4,399,860 | DEL | A | A_01370001_002:391 | Perfect | tig00000499 |
| | | | | | 8691-3918691 | match | |
| chr20 | 7,458,207 | 7,458,445 | DEL | A | A_01370001_001:804 | Perfect | tig00000430 |
| | | | | | 521-804521 | match | |
| chr20 | 8,586,996 | 8,587,157 | DEL | A | A_01370001_001:193 | Perfect | tig00000391 |
| | | | | | 3527-1933527 | match | |
| chr20 | 16,133,474 | 16,133,474 | INS | A | A_01370002_001:267 | Reasonable | tig00000146 |
| | | | | | 072-267124 | match | |
| chr20 | 16,169,497 | 16,169,497 | INS | A | A_01370002_001:303 | Perfect | tig00000146 |
| | | | | | 056-303200 | match | |
| chr20 | 18,794,815 | 18,795,135 | DEL | B | B_01370014_001:474 | Perfect | tig00000133 |
| | | | | | 483-474483 | match | |
| chr20 | 23,526,216 | 23,526,353 | DEL | A | A_01370003_001:340 | Perfect | tig00000010 |
| | | | | | 134-340134 | match | |
| chr20 | 23,527,766 | 23,527,766 | INS | A | A_01370003_001:341 | Perfect | tig00000010 |
| | | | | | 528-341696 | match | |
| chr20 | 25,540,289 | 25,540,472 | COMPLEX | A | A_01370003_001:235 | Perfect | tig00000398 |
| | | | | | 7667-2357775 | match | |
| chr20 | 33,219,540 | 33,219,594 | DEL | A | A_01640001_001:617 | Perfect | tig00000656 |
| | | | | | 8696-6178696 | match | |
| chr20 | 35,188,116 | 35,188,116 | INS | A | A_01640001_001:424 | Perfect | tig00000232 |
| | | | | | 4038-4244229 | match | |
| chr20 | 35,190,278 | 35,190,443 | DEL | A | A_01640001_001:424 | Perfect | tig00000232 |
| | | | | | 1881-4241881 | match | |
| chr20 | 51,845,284 | 51,845,341 | DEL | B | B_01640034_001:511 | Perfect | tig00000332 |
| | | | | | 35-51135 | match | |
| chr20 | 54,202,888 | 54,202,888 | INS | B | B_01640046_001:984 | Perfect | tig00000087 |
| | | | | | 223-984298 | match | |
| chr20 | 54,203,188 | 54,203,188 | INS | B | B_01640046_001:983 | Perfect | tig00000087 |
| | | | | | 800-983922 | match | |
| chr20 | 54,406,672 | 54,406,672 | INS | A | A_01640002_001:412 | Perfect | tig00000668 |
| | | | | | 8535-4128676 | match | |
| chr20 | 55,992,472 | 55,992,472 | INS | A | A_01640002_003:671 | Perfect | tig00000337 |
| | | | | | 879-671945 | match | |
| chr20 | 58,874,630 | 58,874,630 | INS | A | A_01640002_004:339 | Perfect | tig00000312 |
| | | | | | 618-339674 | match | |
| chr20 | 59,367,195 | 59,367,195 | INS | A | A_01640002_004:833 | Perfect | tig00000290 |
| | | | | | 088-833159 | match | |
| chr20 | 59,478,144 | 59,478,144 | INS | A | A_01640002_004:944 | Perfect | tig00000290 |
| | | | | | 093-944180 | match | |
| chr20 | 59,556,318 | 59,556,318 | INS | B | B_01640053_001:153 | Perfect | tig00000003 |
| | | | | | 874-153958 | match | |
| chr20 | 59,604,103 | 59,604,103 | INS | B | B_01640053_001:106 | Perfect | tig00000003 |
| | | | | | 124-106174 | match | |
| chr20 | 59,621,200 | 59,621,275 | DEL | B | B_01640053_001:890 | Perfect | tig00000003 |
| | | | | | 08-89008 | match | |
| chr20 | 59,865,494 | 59,865,494 | INS | A | A_01640002_004:133 | Perfect | tig00000606 |
| | | | | | 1313-1331530 | match | |
| chr20 | 59,974,166 | 59,974,487 | DEL | A | A_01640002_004:144 | Perfect | tig00000895 |
| | | | | | 4321-1444321 | match | |
| chr20 | 60,948,560 | 60,948,700 | DEL | A | A_01640002_004:242 | Perfect | tig00000390 |
| | | | | | 7006-2427006 | match | |
| chr20 | 60,992,933 | 60,992,933 | INS | A | A_01640002_004:247 | Perfect | tig00000390 |
| | | | | | 2158-2472210 | match | |
| chr20 | 62,807,430 | 62,807,430 | INS | B | B_01640059_001:342 | Perfect | tig00000145 |
| | | | | | 17-34366 | match | |
| chr20 | 62,902,209 | 62,902,425 | DEL | A | A_01640003_001:567 | Perfect | tig00000145 |
| | | | | | 4-5674 | match | |
| chr22 | 24,195,933 | 24,198,505 | DEL | B | B_01040007_001:818 | Perfect | tig00000305 |
| | | | | | 79-81879 | match | |

The combined length of SNVs, indels and SVs that were heterozygous between the two haplotigs was 69.8 Mb. Moreover, the present inventors were able to measure the expression level from each haplotype genome (Table 10).

BACs identified to be discordant in size (>1 kb) were pooled and sequenced with the SMRT platform. The subreads were assembled using Canu after screening and removing Escherichia coli or vector sequences with CrossMatch. The assembled BAC contigs were polished with Quiver. The BAC contigs were, thereafter, used to Validate AK1 assembly-based or phase-specific SVs by assessing the concordance between the assembly and the BAC contig at sites of detected SVs.

Heterozygosity and Allele-Specific Expression

On the basis of the alignments of haplotigs to GRCh37, haplotig A and B were localized to compare partner sequences. The number of different bases were summed in every 5 Mb distance, and percentiled. RNA-seq reads were trimmed and aligned to GRCh37 using STAR aligner with the two-pass mapping strategy as recommended. Duplicates were removed using Picard tools, and variants were called using HaplotypeCaller and VariantFiltration following GATK best practices on RNA-seq.

Haplotypes of human leukocyte antigen (HLA) genes were examined and haplotypes were identified using targeted SMRT sequencing (Table 4).

TABLE 4
HLA-typing results

| HLA Gene | MHC Haplotig A | MHC Haplotig B |
|---|---|---|
| HLA-A | A*32:01:01 | A*24:02:01:01 |
| HLA-B | B*51:01:01:01 | B*58:01:01 |
| HLA-C | C*03:02:02:01 | C*14:02:01 |
| HLA-DRB1 | DRB1*03:01:01:01 | DRB1*15:01:01:01 |
| HLA-DRB3 | DRB3:02:02:01:01 | DRB3:02:02:01:01 |
| HLA-DQA1 | DQA1*05:01:01:01 | DQA1*01:02:01:01 |
| HLA-DQB1 | DQB1*06:02:01 | DQB1*02:01:01 |
| HLA-DPA | DPA1*01:03:01:01 | DPA1*02:02:02 |
| HLA-DPB | DPB1*02:01:02 | DPB1*05:01:01 |

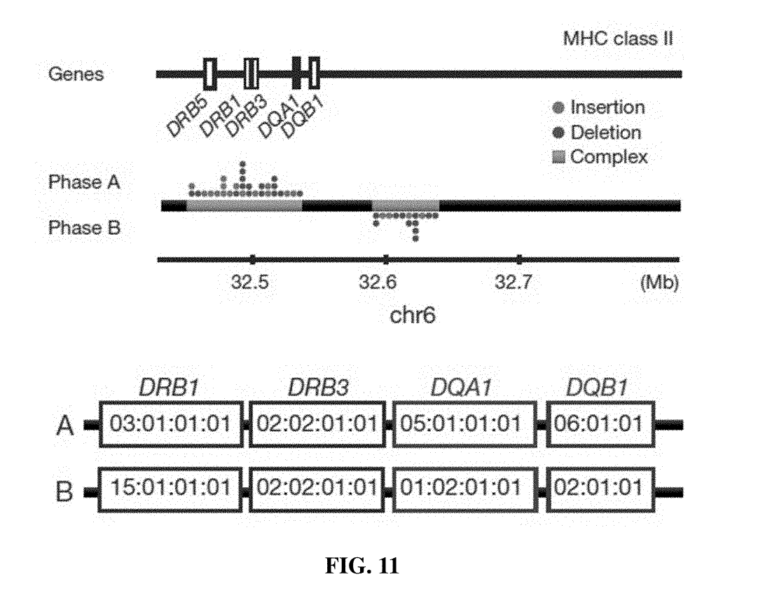

To avoid common problems associated with hyperpolymorphic patterns of allelic variation, major histocompatibility complex (MHC) class I and II regions were assembled independently. The MHC class II region was phased successfully despite a large number of SVs. FIG. 11 represents HLA genes in the MHC class II region. The HLA gene region contains a large number of SVs, which are regions of high diversity and complexity, making it difficult to phase for the reference genome. However, the entire region can be phased through the de novo approach. This demonstrates the usefulness of the de novo phasing approach (FIG. 11).

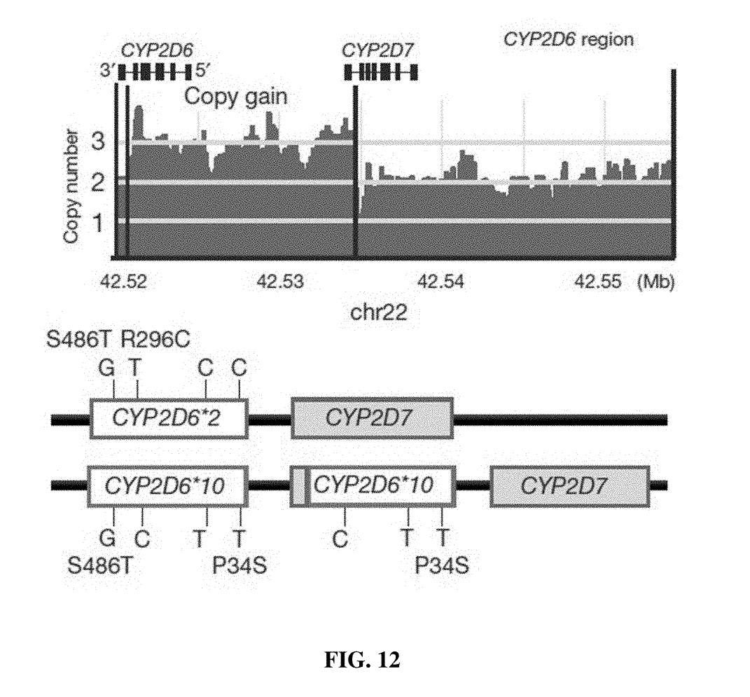

In addition, the method of the present disclosure allowed a clinically important duplication of CYP2D6 to be detected and assigned to one phase. FIG. 12 shows that a duplicated copy of CYP2D6 was fused with the last exon of CYP2D7 on haplotype B. This result demonstrates that de novo assembly-based phasing has advantages in resolving challenging hypervariable regions, and could be used further for pharmacogenomics (FIG. 12).

Allelic configuration is also particularly important for recessive traits. For example, the present inventors were able to phase two genes that contained more than two nonsynonymous, heterozygous alleles known to be associated with recessive diseases (Tables 5 to 9). Variants in MEFV and ADAMTSI3, which are predicted to cause familial Mediterranean fever and Upshaw-Shalman syndrome under the autosomal recessive inheritance pattern, respectively, were found in cis configuration, with the partner haplotype left intact.

TABLE 5
Amino acid changes of heterozygous variants in genes with cis structure 1

| | | | | | | | Num. variants |
|---|---|---|---|---|---|---|---|
| Chr | Start | End | dbSNP144 | Gene | Ref | Alt | in this gene |
| chr9 | 136297737 | 136297737 | novel | ADAMTS13 | C | G | 3 |
| chr9 | 136301982 | 136301982 | rs2301612 | ADAMTS13 | C | G | 3 |
| chr9 | 136305530 | 136305530 | novel | ADAMTS13 | C | G | 3 |
| chr16 | 3293888 | 3293888 | rs1231122 | MEFV | C | T | 4 |
| chr16 | 3299468 | 3299468 | rs11466024 | MEFV | C | T | 4 |
| chr16 | 3299586 | 3299586 | rs11466023 | MEFV | G | A | 4 |
| chr16 | 3304626 | 3304626 | rs3743930 | MEFV | C | G | 4 |

TABLE 6
Amino acid changes of heterozygous variants in genes with cis structure 2

| | | Haplotig: | Clinvar | Polyphen2 | Polyphen2 | Polyphen2 | Polyphen2 |
|---|---|---|---|---|---|---|---|
| Chr | Function | Position | (20150629) | HDIV score | HDIV pred | HVAR score | HVAR pred |
| chr9 | nonsynonymous | B_00130001_{—} | NA | 0.999 | D | 0.917 | D |
| | SNV | 003:132374 | | | | | |
| chr9 | nonsynonymous | B_00130001_{—} | Pathogenic | 0 | B | 0 | B |
| | SNV | 003:136616 | | | | | |
| chr9 | nonsynonymous | B_00130001_{—} | NA | 1 | D | 0.998 | D |
| | SNV | 003:140165 | | | | | |
| chr16 | nonsynonymous | A_01690003_{—} | Pathogenic | . | . | . | . |
| | SNV | 003:604996 | | | | | |
| chr16 | nonsynonymous | A_01690003_{—} | NA | 0.259 | B | 0.045 | B |
| | SNV | 003:610574 | | | | | |
| chr16 | nonsynonymous | A_01690003_{—} | NA | 0.959 | D | 0.503 | P |
| | SNV | 003:610448 | | | | | |
| chr16 | nonsynonymous | A_01690003_{—} | Pathogenic | 0.995 | D | 0.851 | P |
| | SNV | 003:615726 | | | | | |

TABLE 7
Amino acid changes of heterozygous variants in genes with cis structure 3

| | SIFT | SIFT | | GWAS | | Expressed RNA-Seq | Expressed RNA-Seq |
|---|---|---|---|---|---|---|---|
| Chr | score | pred | Trans/Cis | Catalog | Haplotype | Allele Count A | Allele Count B |
| chr9 | 0.21 | T | CIS | NA | B | NA | NA |
| chr9 | 1 | T | CIS | NA | B | 2 | 4 |
| chr9 | 0.12 | T | CIS | NA | B | NA | NA |
| chr16 | 0.26 | T | CIS | NA | A | NA | NA |
| chr16 | 0.23 | T | CIS | NA | A | NA | NA |
| chr16 | 0.05 | D | CIS | NA | A | 0 | 2 |
| chr16 | 0.01 | D | CIS | NA | A | NA | NA |

TABLE 8
Amino acid changes of heterozygous variants in genes with cis structure 4

| | 1000 g | 1000 g | 1000 g | 1000 g | 1000 g | 1000 g |
|---|---|---|---|---|---|---|
| | 2015 August | 2015 August | 2015 August | 2015 August | 2015 August | 2015 August |
| Chr | All | EAS | SAS | EUR | AFR | AMR |
| chr9 | 0.00439297 | 0.0188 | 0.002 | 0.001 | NA | NA |
| chr9 | 0.271565 | 0.1835 | 0.4325 | 0.4254 | 0.0408 | 0.389 |
| chr9 | 0.0323482 | 0.0198 | 0.0276 | 0.0825 | 0.0053 | 0.036 |
| chr16 | 0.353634 | 0.3958 | 0.2352 | 0.4423 | 0.3306 | 0.3746 |
| chr16 | 0.0171725 | 0.0546 | 0.0204 | 0.004 | 0.0015 | 0.0072 |
| chr16 | 0.0201677 | 0.0675 | 0.0215 | 0.004 | 0.0023 | 0.0072 |
| chr16 | 0.126398 | 0.2887 | 0.3047 | 0.0089 | 0.0204 | 0.0115 |

TABLE 9
Amino acid changes of heterozygous variants in genes with cis structure 5

| Chr | Clinvar (details) | AA Change |
|---|---|---|
| chr9 | NA | ADAMTS13:ENST00000536611.1:exon3:c.C32G: |
| | | p.T11R,ADAMTS13:ENST00000371916.1: |
| | | exon7:c.C715G:p.Q239E,ADAMTS13:ENST00000355699.2: |
| | | exon9:c.C1016G:p.T339R, |
| | | ADAMTS13:ENST00000356589.2:exon9:c.C923G: |
| | | p.T308R,ADAMTS13:ENST00000371929.3: |
| | | exon9:c.C1016G:p.T339R |
| chr9 | CLINSIG = pathogenic; CLNDBN = Upshaw- | ADAMTS13:ENST00000536611.1:exon6:c.C358G: |
| | Schulman_syndrome; CLNREVSTAT = no_assertion_criteria_provided; | p.Q120E,ADAMTS13:ENST00000355699.2: |
| | CLNACC = | exon12:c.C1342G:p.Q448E,ADAMTS13: |
| | RCV000006169.3; CLNDSDB = MedGen: | ENST00000356589.2:exon12:c.C1249G:p.Q417E, |
| | OMIM: Orphanet: SNOMED_CT; CLNDSDBID = | ADAMTS13:ENST00000371929.3:exon12: |
| | C1268935: 274150: ORPHA54057: | c.C1342G:p.Q448E |
| | 373420004 | |
| chr9 | NA | ADAMTS13:ENST00000536611.1:exon10:c.C868G: |
| | | p.P290A,ADAMTS13:ENST00000355699.2: |
| | | exon16:c.C1852G:p.P618A,ADAMTS13: |
| | | ENST00000356589.2:exon16:c.C1759G:p.P587A, |
| | | ADAMTS13:ENST00000371929.3:exon16: |
| | | c.C1852G:p.P618A |
| chr16 | CLINSIG = non-pathogenic, non- | MEFV:ENST00000541159.1:exon8:c.G1306A: |
| | pathogenic; CLNDBN = not_provided, Familial_Mediterranean_fever; | p.G436R |
| | CLNREVSTAT = | |
| | criteria_provided\x2c_single_submitter, | |
| | criteria_provided\x2c_multiple_submitters\ | |
| | x2c_no_conflicts; CLNACC = RCV000126738.1, | |
| | RCV000030177.2; CLNDSDB = | |
| | MedGen, GeneReviews: MedGen: | |
| | OMIM: Orphanet: SNOMED_CT; CLNDSDBID = | |
| | CN221809, NBK1227: C0031069: | |
| | 249100: ORPHA342: 12579009 | |
| chr16 | NA | MEFV:ENST00000536379.1:exon2:c.G590A: |
| | | p.R197Q,MEFV:ENST00000541159.1:exon2: |
| | | c.G590A:p.R197Q,MEFV:ENST00000219596.1: |
| | | exon3:c.G1223A:p.R408Q,MEFV:ENST00000339854.4: |
| | | exon3:c.G683A:p.R228Q |
| chr16 | NA | MEFV:ENST00000536379.1:exon2:c.C472T: |
| | | p.P158S,MEFV:ENST00000541159.1:exon2: |
| | | c.C472T:p.P158S,MEFV:ENST00000219596.1: |
| | | exon3:c.C1105T:p.P369S,MEFV:ENST00000339854.4: |
| | | exon3:c.C565T:p.P189S |
| chr16 | CLINSIG = pathogenic; CLNDBN = Familial_mediterranean_fever\ | MEFV:ENST00000219596.1:exon2:c.G442C: |
| | x2c_autosomal_dominant; | p.E148Q |
| | CLNREVSTAT = no_assertion_criteria_provided; | |
| | CLNACC = RCV000002664.1; | |
| | CLNDSDB = MedGen: OMIM: Orphanet; | |
| | CLNDSDBID = C1851347: 134610: | |
| | ORPHA342 | |

As such, by modifying the sequence information of the reference genome through a multiple dot plot analysis method of the de novo assembled test sequence and reference genome sequence according to the present disclosure, the completeness of a reference genome is improved, and thus it is expected that the development of disease prediction or diagnosis methods based on genome structure variation will become possible more effectively.

What is claimed is:

1. A genome analysis method for modifying reference assembly sequence information for a previously known target genome with a de novo assembled test sequence, the method comprising:
(a) reconstructing the entire sequence by assembling a genome for test sequence with a de novo genome assembly;
(b) comparing the reference sequences to each other to generate a self-similarity dot-plot;
(c) identifying a sequence gap on a self-similarity dot plot matrix of a reference sequence;
(d) selecting a sequence at a corresponding position in the sequence mapped to a reference sequence region, and comparing the de novo genome assembled test sequences to each other to generate a self-similarity dot plot;
(e) identifying a sequence gap shown in the reference sequence by aligning the self-similarity dot plot of the de novo genome assembled test sequence and the self-similarity dot plot of the reference sequence on a screen in accordance with the size ratios; and
(f) closing or extending the sequence gap shown in the reference sequence with the de novo genome assembled test sequence.

2. The method according to claim 1, further comprising using local realignment or reassembly, or spanning long read.

3. The method according to claim 1, wherein the target genome is a genomic sequence or part thereof derived from a prokaryote, eukaryote, bacteria, virus, animal, plant, or human.

4. The method according to claim 1, wherein the modification of the reference sequence information is a gap closing or a gap extending.

5. The method according to claim 1, wherein the de novo assembly of the test sequence includes a combination of one or more of PacBio SMRT long read, BioNano Genomics next-generation maps, Illumina HiSeq short read, 10× Genomics GemCode linked read and BAC clone sequencing methods.

6. A method of identifying a gene variation comprising a single nucleotide polymorphism (SNP), insertion deletion (indel) or structural variant (SV) on a genomic sequence of a subject specimen, as compared to the modified reference sequences and/or de novo assembled test sequences according to the method of claim 1.

7. The method according to claim 6, wherein the gene variation includes a haplotype-specific single nucleotide polymorphism, insertion deletion, or structural variants as compared to the genome sequence information of the subject specimen, wherein the de novo assembled test sequence additionally constitutes the de novo assembly of haplotig to represent the haplotype on the chromosome.

8. A system for modifying a reference assembly for a previously known target genome with a de novo assembled test sequence, the system comprising:
(a) a genome assembly unit for reconstructing the entire sequence by assembling a genome for a test sequence with a de novo genome assembly;
(b) a dot plot generating unit for comparing the reference sequences with each other to generate a self-similarity dot plot;
(c) a dot plot analyzing unit for identifying a sequence gap on a self-similarity dot plot matrix of the reference sequence;
(d) a dot plot generating unit for selecting a sequence of a position corresponding to a sequence mapped to the reference sequence region and comparing the de novo genome assembled test sequences to each other to generate a self-similarity dot plot;
(e) a multiple dot plot analyzing unit for aligning the self-similarity dot plot of the de novo assembled test sequence and the self-similarity dot plot of the reference sequence on a screen in accordance with the size ratios to identify the sequence gap appearing in the reference sequence; and
(f) a sequence information correction unit for closing or extending the sequence gap shown in the reference sequence with the de novo assembled test sequence.
